(19) United States
(12) Patent Application Publication
(10) Pub. No.: US 2008/0286590 A1
(43) Pub. Date: Nov. 20, 2008

(54) Ceramic and Metallic Components and Methods for Their Production from Flexible Gelled Materials

(75) Inventors: John Besida, South Freemantle (AU); George V. Franks, Dudley (AU); David E. Dunstan, West Brunswick (AU)

Correspondence Address: WOLF GREENFIELD & SACKS, P.C., 600 ATLANTIC AVENUE, BOSTON, MA, 02210-2206, US

(73) Assignees: Albright & Wilson (Australia) Limited, Yarraville (AU); Commonwalth Scientific and Industrial Research Organisation, Campbell (AU); Tridan Limited, Melbourne (AU); University of Melbourne, Parkville (AU); University of Newcastle, Callaghan (AU)

(21) Appl. No.: 11/661,073

(22) PCT Filed: Aug. 24, 2005
(86) PCT No.: PCT/AU05/01271

§ 371 Date: Apr. 3, 2007

(30) Foreign Application Priority Data
Aug. 24, 2004 (AU) 2004904832
Apr. 8, 2005 (AU) 2005901759

(51) Int. Cl. B32B 27/34; B05D 3/02

(52) U.S. Cl. 428/477.7; 427/383.1; 427/385.5; 428/702; 428/500; 427/376.2; 427/376.6

(57) ABSTRACT

According to one embodiment of the present invention there is provided a method of producing a sheet of flexible gelled ceramic and/or metallic containing material, comprising the steps of: (a) combining water, ceramic and/or metallic powder, polymer, plasticiser, water soluble cross-linking agent precursor and optional further components to produce a mixture; (b) applying the mixture to a suitable substrate to form a layer of desired dimensions; (c) exposing the layer to conditions suitable for cross-linking to occur. According to another embodiment of the present invention there is provided a method of producing a ceramic and/or metallic component comprising the steps of: (a) combining water, ceramic and/or metallic powder, polymer, plasticiser, water soluble cross-linking agent precursor and optional further components to produce a mixture; (b) applying the mixture to a suitable substrate to form a layer of desired dimensions; (c) exposing the layer to conditions suitable for cross-linking to occur; (d) optionally removing from the substrate a flexible gelled material obtained following step (c); (e) optionally drying the flexible gelled material; (f) processing the flexible gelled material to desired shape; (g) firing flexible gelled material of desired shape to produce a ceramic and/or metallic component. Preferably the ceramic and/or metallic component is a component of a fuel cell, photo-voltaic cell, multi-layered capacitor or other micro-electronic component, prosthetic or surgical devices, refractory equipment, fibre optic device or transmission equipment.

### FIELD OF THE INVENTION

The present invention relates to methods of forming ceramic and metallic components, and in particular, but not exclusively, to methods of forming ceramic and metallic components from flexible gelled ceramic and/or metallic containing material (preferably in the form of a sheet, coating or film). The invention also relates to the ceramic and metallic components themselves, as well as to the flexible gelled ceramic and/or metallic containing material from which the components are formed.

### BACKGROUND OF THE INVENTION

There is increasing need to produce ceramic and/or metallic components, which may have utility for example in solid oxide fuel cells, photo-voltaic cells, multi-layered capacitors and other micro-electronic components as well as prosthetic devices and components of refractory equipment. It is impractical to cast ceramics from the molten state as is commonly done with many metal alloys. This is primarily due to the requirement of a highly refined defect free microstructure necessary to produce reliable components with properties for high performance applications. Furthermore the high melting temperature and/or decomposition of ceramic materials makes melt formation impossible or economically impractical.

Although metallic components can be cast from the molten state such processes are highly energy inefficient. There are also circumstances, such as when metallic surfaces are to be deposited on other materials or when components having composite properties (eg. metallic and ceramic properties) are required, where casting from the molten state is either not appropriate or not optimal.

High performance ceramic materials must be made from fine powders that sinter (densify) at a temperature below their melting point. The reduction in free surface energy is the driving force for the elimination of porosity and the densification.

Ceramics are inherently brittle materials and are thus sensitive to flaws, which reduce the strength and reliability of the final article. The strength (S) depends on the fracture toughness of the material (K_{IC}) and the size of the flaw or crack (c) in accordance with the formula S=YK_{IC}/√c. The fracture toughness is a material property and Y a geometric factor that depends upon the details of the flaw shape. Large flaws and cracks greatly reduce the strength of the material.

Dry pressing processes for ceramic production result in inhomogeneous green density, which results in flaws that reduce strength and reliability. The dry processing technique is deficient in that there is no capacity to de-agglomerate the dry powder and remove flaws from the powder that may exist in the as received raw material, or were accidentally added to the powder during processing.

Wet colloidal processing can be used to overcome the deficiencies of dry powder processing. The colloidal method may be used to break down agglomerates and remove flaws via filtration, sedimentation or other means to produce nearly defect free uniform density green bodies. This results in improved strength and reliability of the final component(^{7, 10}).

Ceramics are extremely hard materials and thus are difficult to machine. Expensive diamond grinding is often required in order to finish articles produced by known methods. Thus it is economically advantageous to produce a component which does not require machining, or requires only minimal machining after sintering has taken place. Processes that do not require machining after forming of the component are known as net shape processes and these constitute the most desirable approach.

Several methods of producing near net shaped ceramic articles from powders currently exist, such as thermoplastic injection of powders with binders that melt (U.S. Pat. No. 3,351,688), such as paraffin wax (U.S. Pat. No. 4,011,291), thermoplastic polymeric resins (U.S. Pat. No. 4,144,207) and polymer mixtures (U.S. Pat. No. 4,571,414). Low pressure injection moulding(⁸) processes, including the Quickset injection moulding process, (U.S. Pat. No. 5,047,181, U.S. Pat. No. 5,047,182) have also been used.

More recently another pourable or low pressure injection mouldable process that utilises an aqueous system has been disclosed(¹) (U.S. Pat. No. 5,667,548, U.S. Pat. No. 5,788,891, U.S. Pat. No. 5,948,335). This method relies on a chemically activated change in solution conditions that changes the particle-particle interaction from repulsive to attractive. This process requires particularly long retention times in the mould to achieve strength of the article sufficient to allow successful removal of the mould. Janney and coworkers (U.S. Pat. No. 4,894,194, U.S. Pat. No. 5,028,362, U.S. Pat. No. 5,145,908) have disclosed a process that utilises the polymerisation of a monomer in the suspension solution via a free radical initiator. This process produces strong de-mouldable bodies relatively quickly. There is only a relatively small amount of the polymer in the green body (article before firing) so it is relatively easy to burn out. Unfortunately, however, most of the monomer-initiator systems suitable for the process are somewhat toxic. The mechanical behaviour of bodies produced with this method are indicative of very limited flexibility and thus may be fractured when large strains are applied to the component during de-moulding.

Methods suitable for filling moulds via low pressure injection moulding or pouring that utilise aqueous solutions of gelling bio-polymers have also been disclosed. These methods(⁴) (U.S. Pat. No. 4,734,237, U.S. Pat. No. 5,286,767, U.S. Pat. No. 5,503,771) generally utilise physical gelation of bio-polymers such as agar, alginate, gelatine, or pectin. These systems gel when the temperature is decreased, and the gelation is reversible. The disadvantage of these types of systems is that they will re-liquefy when heated again, for instance during drying and sintering of the article. The method disclosed by Rivers (U.S. Pat. No. 4,113,480) utilises methylcellulose, which gels as the temperature is increased. All these methods rely on the gelation to proceed by a mechanism in which the polymer chains form intertwined coils held together by physical bonds. With these methods the polymer chains are not chemically cross-linked.

International Patent Publication No. WO 01/76845 to Franks et al (the disclosure of which is included herein by way of reference) discloses methods of forming net shaped or near net shaped articles that involve incorporation within a mould of a suspension of a polymer, ceramic and/or metallic powder and a cross-linking agent precursor in a solvent. On activation of the cross-linking agent precursor a gel is formed that is flexible and of sufficient strength to withstand removal from the mould. The solvent may then be removed by drying before the article is subject to sintering.

An alternative approach to the net shape or near net shape processes discussed above is tape casting. Tape casting is a technique used to prepare thin ceramic sheets required for the fabrication for example of ceramic components such as those used in solid oxide fuel cells, photo-voltaic cells, multi-layered capacitors and other micro-electronic components as well as prosthetic devices and components of refractory equipment. Tape casting has in the past been performed using slurries containing a ceramic powder, dispersed in a relatively volatile non-aqueous solvent, together with a number of additives including organic binders, plasticisers, dispersants and surfactants(^{12,13}). Once the tape is cast, evaporation of the solvent produces a thin ceramic sheet having the flexibility and structural integrity to be rolled and cut or otherwise formed into the desired shape, prior to firing.

Recently, the environmental and toxicological aspects of the organic solvents used in tape casting have come under close scrutiny and alternative slurry formulations, using aqueous media, have been investigated. Aqueous slurries for tape casting have the advantage of being non-flammable, non-toxic and less expensive compared to their organic solvent based analogues.

Typical aqueous tape casting formulations have contained a ceramic powder, at least one water soluble binder such as polyvinyl alcohol (PVA), polyvinyl acetate (PVAc), various cellulose derivatives, acrylic emulsion binders etc. and at least one water soluble plasticizer such as glycerin, glycerol, polyethylene glycol (PEG), polypropylene glycol (PPG), di-butyl phthalate (DBP) etc.(¹⁴⁻²¹). Following casting, the aqueous based films are dried for several hours to produce tapes that can be processed in a similar manner to those using non-aqueous solvents. However, a major drawback of aqueous tape casting is the extended period of time required for tape drying, which is usually much longer than that required when organic solvent based formulations are used. Tapes cast from aqueous based systems in the past have also been prone to cracking(^{15,18}). In order to shorten the length of time between casting and tape consolidation, a number of alternative aqueous methods, which involve some form of gelation, have been explored. These include alginate gelation with Ca(II) ions(¹⁸) and gel-casting using acrylamide monomer. Most of these methods have severe limitations. For example, tape casting formulations containing alginate require the as-cast tape to be immersed in a CaCl₂ solution for gelation to occur. As well as being unpractical, this procedure also introduces Ca²⁺ into the ceramic matrix, which could restrict subsequent use of the ceramic sheet for certain applications. From a safety point of view, gel-casting using acrylamide monomer is extremely hazardous since acrylamide has been shown to be highly neurotoxic.

The present inventors have now demonstrated that it is possible to produce a flexible gelled sheet material that may be used for production of ceramic and/or metallic components, by a method involving the combination of water, ceramic and/or metallic powder, polymer, plasticiser and water soluble cross-linking agent precursor, to produce a mixture that may be applied as a layer to a suitable substrate. Under appropriate conditions the cross-linking agent will be activated to initiate cross-linking, such that a flexible gelled ceramic and/or metallic material is produced. This approach is believed to constitute an improvement on previous aqueous tape casting procedures in that by adopting a water soluble cross-linking agent precursor it is possible to generate a cross-linked polymer network in the slurry, to form a gel. A flexible sheet material can therefore be produced relatively quickly without the need for prior solvent evaporation. The flexible sheet material (or “green body”, which has essentially the form of the end product, but which is flexible and able to be machined before being transformed into the final product by drying and sintering) also has a superior “green” strength in comparison to sheets formed by conventional practices, which employ binders without any cross-linking, and thus has a reduced tendency for cracking during drying.

It has been stated in the literature that slurries having a solid loading of >50 vol % are required for gel-casting to produce dense specimens, since there is no opportunity to concentrate the slurries during gelation. This appears to be true for gel-casting formulations for example containing acrylamide and its derivatives. However, the system devised by the present inventors displays unusual characteristics in that gelation leads to unprecedented levels of cross-linking and syneresis. This results in an unexpected level of concentration of the slurry during gellation to give relatively dense “green” bodies, even when the initial slurry solid loading is as low as 30-35 vol %. In essence, the present formulations have the potential to utilise slurries of low solid loading and viscosity, enabling easy de-gassing to be performed, to produce dense “green” bodies, which can be easily machined before firing.

Examples of other possible advantages of the present approach include
1) Gelled sheet material is flexible and can be easily manipulated into desired shapes, such as tubing, before drying.
2) Cross-linking enables less binder to be used than in conventional tape casting.
3) Less binder equates to shorter binder burn-out times.
4) Flexible “green” sheet material characteristics can be altered and adapted for different applications.
5) An aqueous based system avoids safety and environmental concerns associated with solvent based systems.

It is with the above background in mind that the present invention has been conceived.

### SUMMARY OF THE INVENTION

According to one embodiment of the present invention there is provided a method of producing a sheet of flexible gelled ceramic and/or metallic containing material, comprising the steps of:
(a) combining water, ceramic and/or metallic powder, polymer, plasticiser, water soluble cross-linking agent precursor and optional further components to produce a mixture;
(b) applying the mixture to a suitable substrate to form a layer of desired dimensions;
(c) exposing the layer to conditions suitable for cross-linking to occur.

In a preferred embodiment of the invention the method comprises a further step of removing from the substrate a flexible gelled material obtained following step (c).

In another preferred embodiment of the invention the above methods comprise a further step of drying of a flexible gelled material obtained following step (c).

According to another embodiment of the present invention there is provided a method of producing a ceramic and/or metallic component comprising the steps of:
(a) combining water, ceramic and/or metallic powder, polymer, plasticiser, water soluble cross-linking agent precursor and optional further components to produce a mixture;
(b) applying the mixture to a suitable substrate to form a layer of desired dimensions;
(c) exposing the layer to conditions suitable for cross-linking to occur;
(d) optionally removing from the substrate a flexible gelled material obtained following step (c);
(e) optionally drying the flexible gelled material;
(f) processing the flexible gelled material to desired shape;
(g) firing flexible gelled material of desired shape to produce a ceramic and/or metallic component.

Preferably the ceramic and/or metallic component is a component of a fuel cell, photo-voltaic cell, multi-layered capacitor or other micro-electronic component, prosthetic or surgical devices, refractory equipment, fibre optic device or transmission equipment.

In preferred embodiments of the invention the polymer may be selected from the group comprising chitosan, polyvinylalcohol, gelatine, poly(allyl)amine, polyethylenimine, chitin, polyacrylic acid, polyvinylacrylate, polyacrylate, polyacrylamide, pectin, xanthan gum, polymers having amide, amine, carboxylic acid and/or hydroxyl functionalities, and mixtures thereof.

Preferably the water soluble cross-linking agent precursor is temperature activated. Preferably the cross-linking agent precursor forms a multifunctional aldehyde upon temperature increase, and particularly preferably the cross-linking agent precursor forms a di-aldehyde upon temperature increase.

In a preferred embodiment of the invention the cross-linking agent precursor is 2,5-dimethoxy-2,5-dihydrofuran (DHF).

In preferred embodiments of the invention the ceramic powder comprises one or more of alumina, zirconia, silica, titania, silicon nitride, silicon carbide and aluminium nitride.

In another embodiment of the invention the optional further components comprise one or more of binders, dispersants, chelating agents, surfactants, defoaming and/or wetting agents, salts, colouring agents, buffers, acid and alkali.

According to another embodiment of the invention there is provided a flexible gelled ceramic and/or metallic containing material comprising ceramic and/or metallic powder dispersed within an aqueous compatible cross-linked polymer.

In a still further embodiment the invention relates to a sheet of flexible gelled ceramic and/or metallic containing material produced according to a method comprising the steps of:
(a) combining water, ceramic and/or metallic powder, polymer, plasticiser, water soluble cross-linking agent precursor and optional further components to produce a mixture;
(b) applying the mixture to a suitable substrate to form a layer of desired dimensions;
(c) exposing the layer to conditions suitable for cross-linking to occur.

In a preferred embodiment of the invention the flexible gelled material is produced according to a method further comprising the step of removing from the substrate a flexible gelled material obtained following step (c).

In another preferred embodiment of the invention the flexible gelled material is produced according to a method further comprising the step of drying of a flexible gelled material obtained following step (c).

According to another embodiment of the present invention there is provided a ceramic and/or metallic component produced according to a method comprising the steps of:
(a) combining water, ceramic and/or metallic powder, polymer, plasticiser, water soluble cross-linking agent precursor and optional further components to produce a mixture;
(b) applying the mixture to a suitable substrate to form a layer of desired dimensions;
(c) exposing the layer to conditions suitable for cross-linking to occur;
(d) optionally removing from the substrate a flexible gelled material obtained following step (c);
(e) optionally drying the flexible gelled material;
(f) processing the flexible gelled material to desired shape;
(g) firing the flexible gelled material of desired shape to produce a ceramic component.

Preferably the component is a component of a fuel cell, photo-voltaic cell, multi-layered capacitor or other micro-electronic component, prosthetic device or refractory equipment.

According to another preferred embodiment of the present invention there is provided a method of producing a sheet of flexible gelled ceramic containing material, comprising the steps of:
(a) combining water, ceramic powder, polymer, plasticiser, water soluble cross-linking agent precursor and optional further components to produce a mixture;
(b) applying the mixture to a suitable substrate to form a layer of desired dimensions;
(c) exposing the layer to conditions suitable for cross-linking to occur;
   wherein the polymer is selected from chitosan, polyvinylalcohol, gelatine, poly(allyl)amine, polyethylenimine, chitin, polyacrylic acid, polyvinylacrylate, polyacrylate, polyacrylamide, pectin, xanthan gum and mixtures thereof and wherein the cross-linking agent precursor forms a multifunctional aldehyde upon temperature increase.

According to another preferred embodiment of the present invention there is provided a sheet of flexible gelled ceramic containing material comprising ceramic powder dispersed within an aqueous compatible cross-linked polymer, wherein the polymer is selected from chitosan, polyvinylalcohol, gelatine, poly(allyl)amine, polyethylenimine, chitin, polyacrylic acid, polyvinylacrylate, polyacrylate, polyacrylamide, pectin, xanthan gum and mixtures thereof and wherein cross-linking is achieved using a cross-linking agent precursor that forms a multifunctional aldehyde upon temperature increase.

According to a still further embodiment of the present invention there is provided a method of producing a ceramic component comprising the steps of:
(a) combining water, ceramic powder, polymer, plasticiser, water soluble cross-linking agent precursor and optional further components to produce a mixture;
(b) applying the mixture to a suitable substrate to form a layer of desired dimensions;
(c) exposing the layer to conditions suitable for cross-linking to occur;
(d) optionally removing from the substrate a flexible gelled material obtained following step (c);
(e) optionally drying the flexible gelled material;
(f) processing the flexible gelled material to desired shape;
(g) firing flexible gelled material of desired shape to produce a ceramic component;
   wherein the polymer is selected from chitosan, polyvinylalcohol, gelatine, poly(allyl)amine, polyethylenimine, chitin, polyacrylic acid, polyvinylacrylate, polyacrylate, polyacrylamide, pectin, xanthan gum and mixtures thereof and wherein the cross-linking agent precursor forms a multifunctional aldehyde upon temperature increase.

### BRIEF DESCRIPTION OF THE FIGURES

The present invention will be further described, by way of example only, with reference to the figures which show as follows:

FIG. 1. The storage modulus of a 1.5 wt % chitosan/2.5×10⁻² mole dm⁻³ DHF solution at pH=1.4 as a function of temperature and time. =40° C.; ∘=50° C.; ▴=60° C.; Δ=70° C.; ♦=80° C.; ⋄=90° C.; ▾=98° C.

FIG. 2. The storage modulus of a 1.5 wt % chitosan/2.5×10⁻² mole dm⁻³ DHF solution as a function of both time and several pH conditions. The temperature was 80° C. The pH was =0.9; ∘=1.4; ▴=2.1; ⋄=3.1; ♦=3.9.

FIG. 3. The storage modulus of a 1.5 wt % chitosan solution at pH=1.4 as a function of both DHF concentration and time. The temperature was 80° C. The DHF concentration was =1.0×10⁻² mole dm⁻³; ∘=2.5×10⁻² mole dm⁻³; ▴=5.0×10⁻² mole dm⁻³; Δ=1.0×10⁻¹ mole dm⁻³.

FIG. 4. Viscosity verses shear rate for a 45 v % AKP-30 alumina suspension in a 1.0 wt % (per solution weight) solution at 20° C. at pH =1.1; ∘=1.4; ▴=2.2; ⋄=3.2; ♦=4.5.

FIG. 5. Shear modulus as a function of time for 45 V % alumina suspensions in 1.0 wt % chitosan solutions with 100 mM DHF at pH 2.2, at various temperatures. , 20° C.; ∘, 60° C.; ▴, 80° C.; Δ, 98° C.

FIG. 6. Shear modulus as a function of time for a 45 v % AKP-30 alumina suspension in a 1.0 wt % (per solution weight) solution with 100 mM DHF at 80° C. at pH =1.1; ∘=1.4; ▴=2.2; Δ=3.2; ♦+=4.5.

FIG. 7. Shear modulus as a function of time for a 45 v % AKP-30 alumina suspension in a 1.0 wt % (per solution weight) solution at pH 2.2 at 80° C. with various DHF concentrations =20 mM; ∘=50 mM; ▴=100 mM; Δ=200 mM.

FIG. 8. Shear modulus as a function of time for a 40 v % AKP-30 alumina suspension in a 0.5 wt % (per solution weight) solution at pH 2.9 at 90° C. with various DHF concentrations =10 mM; ⋄=30 mM; ▴=50 mM; Δ=100 mM.; +=200 mM.

FIG. 9. Photograph of a sheet of flexible gelled ceramic containing material produced according to the invention.

FIG. 10. Viscosity verses shear rate of gelcasting suspensions containing 45 V % alumina, 1.0 wt % (by solution wt.) chitosan, at pH 2.2 and 25° C., with different concentrations of DHF as indicated. Measurements taken two hours after the addition of DHF.

FIG. 11. Effect of DHF concentration on the viscosities (at 0.1 s⁻¹) of suspensions prior to gelation and the strength of bodies after gelation. Data transcribed from FIGS. 12 and 14.

FIG. 12. Effect of pH on the viscosity (at 25° C. and 0.1 s⁻¹) of suspensions prior to gelation and the strength of the body after gelation. The suspensions contained 45 V % alumina, 1.0 wt % (by solution wt.) chitosan, 200 mM DHF, and were gelled at 85° C. for 30 mins.

FIG. 13. Effect of heat treatment time on the strength of wet gelled bodies. The suspensions contained 45 V % alumina, 1.0 wt % (by solution wt.) chitosan, 100 mM DHF, at pH 2.2 and were gelled at 85° C. for the indicated times.

FIG. 14. Stress-strain behaviour of cylinders made from suspensions containing 45 V % alumina, 1.0 wt % (by solution wt.) chitosan, 100 mM DHF, at pH 2.2 heat treated for 30 mins at the indicated temperatures.

FIG. 15. Shear modulus as a function of time for a 30 v % Zirconia suspension in a 1.0 wt % chitosan solutions with 80 mM DHF at pH 2.2 at various temperatures 20° C., ∘ 60° C., ▴ 80° C., Δ 98° C.

FIG. 16. Shear modulus as a function of time for a 30 v % Zirconia suspension in a 1.0 wt % (per solution weight) solution at pH 2.2 at 80° C. with various DHF concentrations θ=20 mM, ∘=50 mM, ▴=80 mM, Δ=100 mM.

FIG. 17. Shear modulus as a function of time for a 45 v % Silicon nitride suspension in a 1.0 wt % chitosan solutions with 80 mM DHF at pH 2.0 at various temperatures 20° C., ∘ 60° C., ▴ 80° C., Δ 98° C.

FIG. 18. Shear modulus as a function of time for a 45 v % Silicon nitride suspension in a 1.0 wt % (per solution weight) solution at pH 2.0 at 80° C. with various DHF concentrations =20 mM, ∘=50 mM, ▴=80 mM.

FIG. 19. Shear viscosity as a function of shear rate for alumina suspensions (prepared according to Example 11, and including 4 wt % polyvinyl alcohol) over a range of solids concentrations ranging from 33.5 to 37 volume percent solids.

FIG. 20. Shear viscosity as a function of shear rate for 33.5 volume % alumina suspensions (prepared according to Example 11, and including 4 wt % polyvinyl alcohol) at the weight percentages indicated.

FIG. 21. Photograph of material prepared according to Example 11 during cross-linking. Although the tape surface remains flat, water droplets appear on the surface due to syneresis of the polymer network and consolidation of the tape.

FIG. 22. The material (shown in the top panel) is consolidation due to the syneresis of the polymer network during and after cross-linking. As shown in the bottom panel, water droplets are squeezed out of the tape as it consolidates in the direction orthogonal to the substrate.

FIG. 23. Photograph of material prepared according to Example 11 following cross-linking, demonstrating its strength and flexibility.

FIG. 24. Photograph of material prepared according to Example 11 (but excluding cross-linking agent precursor) showing that material is brittle and tears during removal from substrate.

### DETAILED DESCRIPTION OF THE INVENTION

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Documents referred to within this specification are included herein in their entirety by way of reference.

The reference to any prior art in this specification is not, and should not be taken as, an acknowledgment or any form of suggestion that that prior art forms part of the common general knowledge in Australia.

The present invention is concerned with the production of flexible gelled ceramic and/or metallic containing material, which is preferably although not necessarily in sheet form, and in the production of ceramic and/or metallic containing components therefrom. The invention also encompasses the flexible gelled ceramic and/or metallic containing materials and the ceramic and/or metallic components themselves. By adopting the techniques of the invention the components produced can be formed in any of a variety of shapes, which may be appropriate for use, for example, as components in machinery, as tools or household items, as sensors, ornaments or the like. This list of possibilities is, however, not intended to be limiting upon the scope of the invention. In preferred embodiments of the invention the components may constitute components for use in the automotive or aeronautical industries, machine components for use in industrial processing machinery or analytical equipment, plumbing components or electrical components, and in particular the components may comprise components of fuel cells, photo-voltaic cells, multi-layered capacitors or other micro-electronic components, prosthetic or surgical devices, refractory equipment or fibre optic devices or transmission equipment. For example, components of the invention may be used as wear resistant layers on refractory equipment used in foundrys, as couplers in fibre optic systems, as glaze on tiles, sanitary ware, pottery etc, or as load bearing, wear resistant and/or non-immunogenic layers or coatings of prosthetic devices such as artificial joints. It should be understood, however, that use of the term “component” does not necessarily imply that the component must take the form of an element of a larger entity. In the context of use of the term “component” herein the component may constitute either an element of a larger entity or may comprise an entity in itself.

Key ingredients used in production of the components according to the present invention are water, ceramic and/or metallic powder, polymer, plasticiser and water soluble cross-linking agent precursor. Further optional ingredients may be added depending upon the nature of the component to be produced. Such other ingredients may for example comprise dispersants, chelating agents, surfactants, salts, colouring agents, buffers, acid, alkali, etc. Examples of preferred acids include hydrochloric acid, acetic acid, nitric acid, sulfuric acid, phosphoric acid and citric acid. For example, ceramic powders may include one or more of alumina, zirconia, titania, silica, silicon nitride, silicon carbide, aluminium nitride, ceramic superconductors and metallic powders may include one or more metals (including metal alloys) in powder form (such as iron, steel, copper, aluminium, gold, platinum, silver, nickel, lead etc.). Such powders may be combined with water, polymer, plasticiser and cross-linking agent precursor (and optional further components), preferably with mixing, to produce a mixture that preferably comprises an homogenous mixture of elements throughout the suspension, dispersion or solution, as the case may be. For the sake of convenience this suspension, dispersion or solution of ingredients will be referred to throughout as “the mixture”. The mixture will then be applied in an appropriate manner to a suitable substrate.

It is to be understood that depending upon the desired properties of the flexible gelled material and the components ultimately produced it is possible to utilise powdered forms of a plurality of ceramics or powdered forms of a plurality of metals (including metal alloys) or even combinations of metallic and ceramic powders. It is also possible to control the dispersion of particular powders within the mixture (for example using the application of magnetic fields) to control the location of particular elements within the ultimately produced components, for example to give rise to desired electrical, magnetic, heat transmission or optical properties. Microelectronic circuitry may be incorporated in a ceramic/metallic component in this way.

Throughout this document reference to the term “ceramic” is intended to encompass materials and powder forms thereof that may include metal elements but are non-organic and non-metallic in nature and are generally comprised of nitride, oxide, carbide and/or boride compounds. In contrast the term “metallic” is intended to encompass materials and powder forms thereof consisting essentially of metals in their elemental form or as alloys of metals.

Preferably the metallic and/or ceramic powders used in this invention will have average particle diameters of between about 1 nm to about 100 μm, preferably between about 10 nm to about 1 μm. Ceramic and metallic powders useful in the invention can be produced by conventional means and can be obtained from commercial suppliers.

The substrate selected will generally take the form of a substantially non-reactive and preferably water impermeable material such a metal or metal alloy, polymer, plaster or ceramic material. Examples of materials suitable for use as the substrate include plastics, such as polypropylene, mylar and acetate, stainless steel (for example stainless steel mesh), glass and ceramics. The substrate may take the form of a simple planar sheet of material or may have features of surface relief included within it, which may for example assist to retain the mixture, or that may be designed to impose desired features of shape onto the components being produced. The substrate may be completely rigid or may, especially for use in continuous mechanised processes for production of extensive lengths of gelled material, have some flexibility while still offering the structural integrity necessary for production of a gelled material of consistent quality. The substrate should of course maintain the necessary structural integrity under the conditions to which it is exposed in the course of the production process, and in particular those adopted for cross-linking of the polymer within the mixture. Generally a relatively stiff substrate with high thermal conductivity is preferred. These properties allow for quick heat transfer and good dimensional control.

The substrate may also comprise a material or article onto which the mixture is to be deposited to ultimately form a ceramic and/or metallic layer on the material or article. This approach is appropriate in the case of substrate materials or articles that will tolerate the sintering process.

The mixture will be applied to the substrate in a manner that results in generation of a layer of gelled material. This outcome can be achieved by a variety of means, such as by pouring, by brushing, by dripping, by spraying, by pressurised (low or high) injection, by extrusion, by gravity assisted flow, by centrifugally or vibratory assisted flow or by flow assisted by mechanical guides, as used in conventional tape casting, for example. Injecting the suspension onto the substrate (for example from an elongate injection nozzle) under relatively low pressures facilitates complete filling of the substrate and good dimensional control. Application of the mixture to the substrate will preferably be conducted under controlled atmospheric conditions (eg. controlled temperature, humidity and/or pressure) and in a clean room environment to substantially prevent introduction of foreign matter that could lead to imperfections in the components produced.

The mixture may be applied to the substrate in one, two or a plurality of layers, optionally with cross-linking steps conducted in between, to thus generate a layer of gelled material that is in itself comprised of a plurality of layers. Indeed it is also possible to intersperse between layers, layers of other materials such as for example layers (or partial layers) of micro-electronic circuitry, heat and/or electrical insulating and/or conducting material or other materials that will give rise to desirable properties within the components under production.

The mixture may be applied to the substrate in a manner that will allow production of a gelled material of any desired dimensions. For example, in the case of a batch production process sheets of gelled material of length and width between about 1 mm and about 1 m, preferably between about 10 mm and about 100 mm, and with thickness of between about 0.05 mm and about 50 mm, preferably between about 0.1 mm and about 20 mm, may be produced. In the case of continuous or semi-continuous production processes the gelled material may be produced in long lengths, for example from about 2 m to about 100 m, preferably between about 5 m to about 20 m, or in continuous lengths that may be rolled or cut to desired length for further processing.

Cross-linking of the polymer will form a gel, under suitable conditions. Gellation of the polymer within the mixture enables the material to assume a structural state that is flexible but which is resilient, such that it will substantially return to its original three-dimensional shape after being deformed by application of a force. This flexible gelled containing material can readily be handled and can also be easily processed for example by cutting, grinding and/or drilling to produce a layered material, or pieces thereof, with desired features of shape. If produced as a sheet, the flexible gelled material can also be rolled to form pipes or tubes or other desired hollow shapes. This is possible as the flexible gelled material generally exhibits a cohesive property that can be utilised to fuse the material to itself (or other similar layers of material) by placing the material in the desired location and applying a controlled force in the location where joining is required. Such joins will be made permanent following sintering.

Polymers which may be adopted in the methods according to the present invention are those which include amide, amine, carboxylic acid and hydroxyl functional groups. Examples of specific polymers that may be adopted include chitosan, polyvinylalcohol, gelatine, poly(allyl)amine, polyethylenimine, chitin, polyacrylic acid, polyvinylacrylate, polyacrylate, polyacrylamide, xanthan gum and mixtures thereof. The polymer may be formed in situ by the addition of monomeric or oligomeric units to the mixture, along with appropriate initiators, promoters etc. such that polymer is formed within the mixture. The polymer may also comprise a co-polymer.

A particularly preferred polymer according to the present invention is polyvinylalcohol. Polyvinylalcohol (PVA) can be cross-linked by di-aldehydes via reaction of the hydroxyl moieties on the PVA and the carbonyl group of the aldehyde, through the formation of acetal bonds. For example, glutaraldehyde may be used to cross-link PVA almost instantaneously (Braun, et al., 1980). This type of cross-linking does not, however, offer much control in gel formation. Preferably the PVA used in the present invention is commercial grade PVA suitable for ceramics use. Examples of commercially available PVAs include Celvol 203S and Celvol 205S. Polymer chains of PVA 205S are almost twice as long as those of PVA 203S and hence solutions of PVA 205S are slightly more viscous than those of PVA 203S, at identical concentrations of polymer. Both of these PVAs are fine powders and have the special property of being cold water soluble. The present inventors have shown that both Celvol 203S and 205S do not gel as strongly as Celvol 418 at concentrations of 4 wt % in solution; however, strong gels can be obtained when higher concentrations are used. Importantly, solutions of Celvol 203S and Celvol 205S can be prepared at much higher concentration than that of Celvol 418, which is important for tape casting applications.

Another preferred polymer according to the present invention is chitosan. After cellulose, chitin is the most abundant polysaccharide found in nature due to its presence in crustacean shells, insect exoskeletons and fungal biomass (Mathur, et al.). Structurally, it consists primarily of 1,4-linked units of 2-acetamido-2-deoxy-β-D-glucose and, except under highly acidic conditions, is insoluble in aqueous media. The solubility of chitin can be enhanced through a process of de-acetylation, in which the N-acetyl linkage is hydrolysed under very basic conditions to produce an amine moiety. The bio-polymer chitosan results.

Chitosan can be cross-linked by di-aldehydes via by reaction of the amine moieties on the chitosan and the carbonyl group of the aldehyde, by a Schiff base reaction. For example, glutaraldehyde may be used to cross-link chitosan almost instantaneously (Thanoo, et al., 1992). This type of cross-linking does not, however, offer much control in gel formation. If utilised in the present invention the chitosan is preferably enzymic or acid hydrolysed and it is preferably low molecular weight chitosan, for example having molecular weight average of 150,000 Daltons and below. Low molecular weight chitosan is less likely to increase viscosity of the mixture to unacceptable levels than higher molecular weight forms.

The cross-linking agent precursors which may be adopted in the present invention are those which can be activated, for example by an increase in temperature to form a cross-linking agent effective to cross-link the particular polymer or polymer mixture concerned. Preferred cross-linking agents according to the invention include ring opening molecules, and in particular the cross-linking agent precursors may be those that form a multifunctional aldehyde upon increase in temperature. Preferably the multifunctional aldehyde is a di-aldehyde which is formed from the cross-linking agent precursor when it is exposed to increased temperature.

A particularly preferred cross-linking agent precursor is 2,5-dimethoxy-2,5-dihydrofuran (DHF). When present in acidified aqueous solution, 2,5-dimethoxy-2,5-dihydrofuran (DHF) decomposes to yield butenedial according to the scheme (Hansen, et al., 1997):

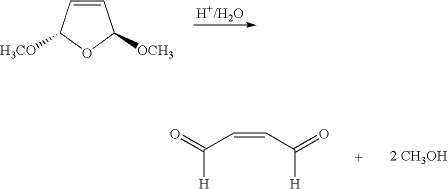

Other cross-linking agent precursors include any molecule that degrades with increase in temperature to produce butanedial, such as furan or its derivatives, or any other molecule that is capable of forming a dialdehyde either through decomposition or isomerism (such as genipin).

Plasticisers that may be utilised in the present invention include polyethylene glycol polypropylene glycol, glycerol and di-butylphthalate, which serve to impart resilience and flexibility upon the flexible gelled material to enable it to be removed from the substrate and worked as necessary without significant degradation.

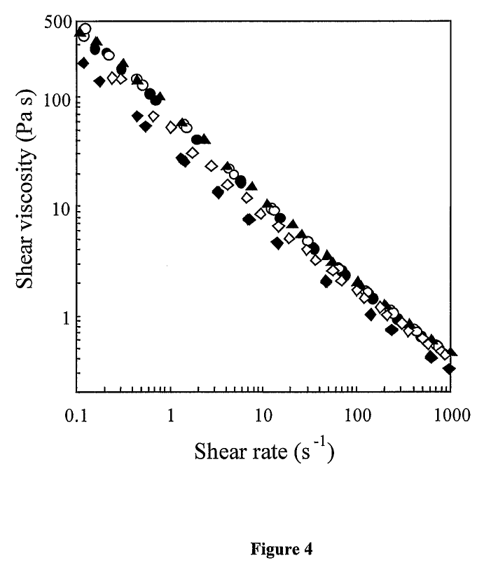

Solutions of the polymer or polymers may be used as the continuous liquid phase in which the ceramic and/or metallic powder (referred to herein as the “powder”) may be dispersed. Usually between 0.1 and 8 wt % of polymer is used relative to weight of powder. Similar concentrations are typical if the polymer concentration is based on slurry weight. The concentration of ceramic powder in the mixture will depend on the particle characteristics, but particle concentrations near the maximum packing are usually preferred. The concentration of powder in the mixtures is typically between 20 and 75 volume percent. A relatively low viscosity (although sometimes shear thinning) mixture (most likely a suspension) is produced so that the mixture may readily be applied to the substrate. FIG. 4 shows the viscosity as a function of shear rate at various pH values of a suspension of alumina in a solution containing the dissolved polymer chitosan. Even though the suspension is suitable for gelation, the behaviour of this suspension is liquid-like and remains thus for at least one week.

When glutaraldehyde is added to the mixture containing chitosan at room temperature gelation begins immediately. Within a minute the suspension behaviour has changed from liquid-like to solid-like. In this case there is insufficient time for the suspension to be stored for any period of time before application to the substrate. The use of glutaraldehyde, glyoxal, ethylene glycol diglycidyl ether, tripolyphosphate, pyrophosphate, oxalate and citrate as cross-linking agents is possible but not preferred since the gelation cannot be controlled by a triggering mechanism such as temperature.

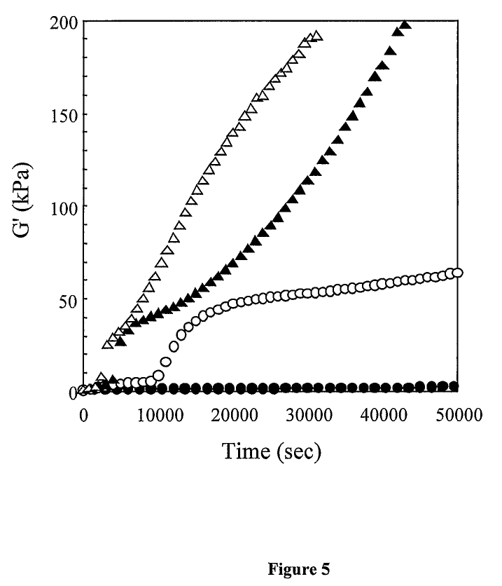

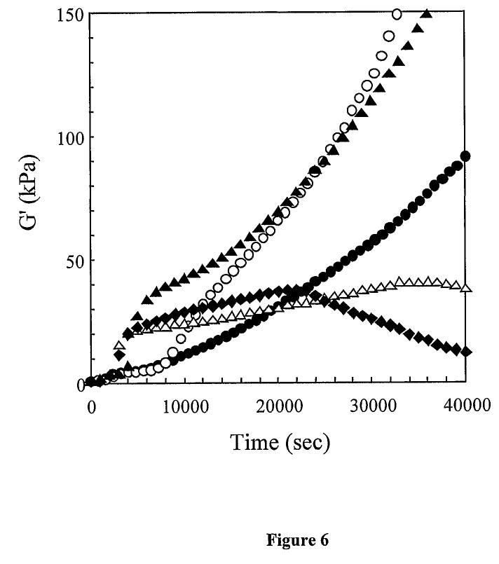

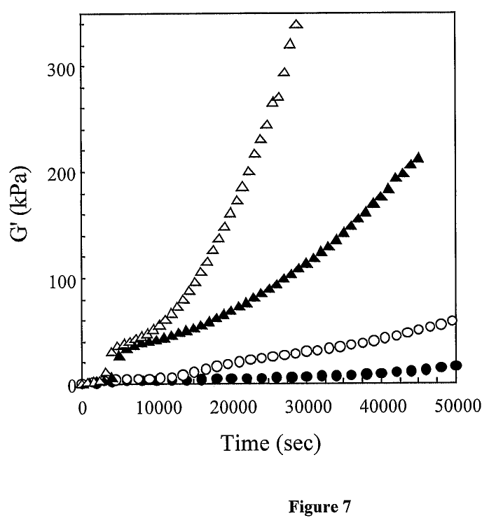

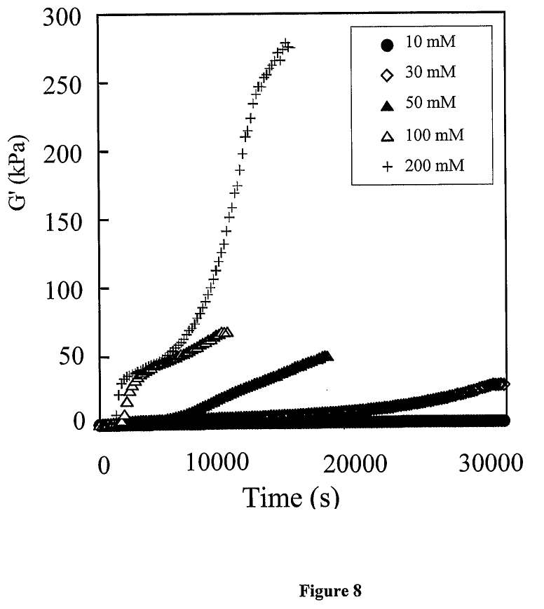

At a suitable pH, when DHF (a ring opening cross-linking agent) is added to the powder polymer mixture the mixture remains liquid-like with a low viscosity for extended periods of time. With continuous mixing the mixture maintains a low viscosity for more than 16 hours (overnight). If left unstirred the viscosity increases slightly overnight due to slow cross-linking resulting from slow decomposition of DHF into butenedial at room temperature. This property of the temperature activated ring opening cross-linking agent is very advantageous to the economical production of substantially defect free components, since it allows for the mixture to be stored for a period of time before application to the substrate, without viscosity increase. It also allows for application of the mixture to the substrate without creating defects, due to the low viscosity of the substrate. Application to the substrate of high viscosity, partially gelled mixtures may lead to defects in the final component. At elevated temperatures typically between 40° C. and 98° C. the mixture gels and becomes solid-like. This behaviour is characterised by the development of and increase in the shear modulus of the suspension (See FIG. 5). This allows for the suspension to be gelled on the substrate to produce an elastic body with suitable strength to be removed from the substrate, if it is desired to do so for processing of the gelled material and/or for drying, before sintering takes place. The rate of gelation and maximum shear modulus of the mixture can be controlled by changing the initial suspension pH. A pH of between 1 and 11 may be adopted, although acidic pH is preferable. The preferred pH appears to be about pH 2 for the system investigated (See FIG. 6) and between pH 1-2 for suspensions containing PVA. Another method used to control the rate of gelation and the final gel modulus and strength is by controlling the concentration of the cross-linking agent. Generally, increasing the cross-linker concentration will increase the rate of gelation and the stiffness of the gelled body formed (See FIGS. 7 and 8).

The slight shear thinning behaviour observed in FIG. 4 is due to the presence of Al³⁺ ions in the solution (dissolved from the alumina particles at low pH) forming weak links between chitosan molecules. The viscosity of the suspension at room temperature (before gelation) may be further reduced by the addition of a chelating agent that binds Al³⁺ ions preventing them from weakly cross-linking the chitosan. Anions such as F⁻ and citrate have been found to be effective in this role. It should be noted that even if no chelating agent is used the links created with polyvalent ions are only weak and reversible, thus not creating a significant problem.

Heat treating the substrate containing the suspension at elevated temperature causes the cross-linking agent precursor to form the active cross-linking agent, which initiates the gelation. DHF and other temperature activated ring opening molecules are particularly advantageous since in the closed ring form they do not cross-link the polymer and the suspension viscosity remains low for extended periods of time, while in the opened form (at higher temperature) these molecules quickly form cross-links resulting in rapid gelation. Temperatures just below the boiling point of water produce the fastest gelation rates, although temperatures above 100° C. may also be utilised. After a period of time the gelled body has sufficient mechanical integrity to be removed from the substrate, if desired, without damage. The temperature used to initiate gelation can be varied from room temperature (approx. 20° C.) or just above to above 100° C. depending upon the desired rate of gelation, the concentration of polymer and cross-linking agent precursor, the pH, the presence of chelating agents and the extent of mixing. Preferably the gelation initiation temperature will be in the range of 40° C. to 98° C.

Numerous means can be utilised to increase the temperature of the substrate and its contents. For example the substrate and its contents may be placed in an oven, water, oil or other liquid bath at controlled temperature (preferably with gelled material protected from direct exposure to the liquid), may be exposed to steam or warm air or other gas or may be exposed to radiation such as microwave radiation, ultraviolet radiation, infrared radiation or visible light, particularly concentrated visible light. Other means of increasing the temperature of the substrate and its contents in order to activate the cross-linking agent precursor to form the cross-linking agent itself, are of course also possible, as would be apparent to persons skilled in the art.

The mechanical behaviour of the gelled body may be controlled by such factors as the concentration of the polymer and cross-linker, the polymer/plasticiser ratio, the extent of cross-linking, time and temperature of heat treatment and concentration of solid particles. In some cases it may be advantageous to produce a high modulus high strength body (for example for wet green machining if desired) while in other cases (such as ceramic tape production) a low modulus moderately strong and flexible body may be desirable. This second type of mechanical behaviour is advantageous since it produces bodies that exhibit large strain to failure ratios, which may minimise damage in substrate removal. These bodies are also able to elastically return to their moulded shape after deformation, rather than cracking.

In a preferred embodiment of the invention cross-linking of the polymer produces consolidation of the gelled material in the direction orthogonal to the substrate, due to syneresis of the polymer network (that is shrinkage of the polymer network during gelation). This syneresis gives rise to consolidation of the gelled body, which results from water being squeezed out from between the particles and the gel. This is a very useful phenomenon, which has been observed to occur with formulations for example containing 60-75 wt % ceramic and/or metallic powder, 17-30 wt % water, 3-5 wt % polymer, 3-9 wt % plasticiser, <1 wt % aqueous acid, <0.5 wt % de-foaming agent and <500 mM of cross-linking agent precursor (relative to volume of water), as it enables mixtures with low viscosity to be used to form gels with in excess of 50 percent by volume of solids content. Such gels are amenable to easy handling and can readily be removed from the substrate without damage. Upon firing these green bodies can give rise to components with very close to full theoretical density. This aspect of the invention is exemplified in Example 11.

It is to be noted that there is considerable flexibility possible in terms of the steps of the process and their order. For example, the step of removing the gelled material from the substrate may be taken at a variety of stages, such as following cross-linking, following drying, after processing to produce desired shape or indeed following firing. Similarly, a drying step, if adopted, may be taken either before or after processing the gelled material to desired shape. The gelled material (also referred to herein as the gelled body) may be dried in accordance with the methods typically used by those well skilled in the art. For example drying may be conducted in an oven, using exposure to warm air or other gas or may be exposed to radiation such as microwave radiation, ultraviolet radiation, infrared radiation or visible light, particularly concentrated visible light. High temperature firing (sintering) processes for hardening of the ceramic and/or metallic components will be adopted, as are well understood in the art. These processes serve to substantially burn off the polymer material to leave behind the hardened ceramic and/or metallic material.

Difficult or costly drying or binder burnout steps are usually not required according to the invention to produce high density, strong, uniform and reliable ceramic and/or metallic components or components with well controlled dimensions. With this method net shape and near net shape high performance ceramic and/or metallic components can be manufactured, although if necessary in particular applications some machining of the sintered article may also be required.

It is also possible due to the plastic nature of the flexible gelled material for this to be applied (for example under vacuum) to surfaces or articles after removal from the substrate. Due to the flexible nature of the material it is able to follow the surface contours or shape of the surface or article to which it is applied. After sintering a hardened layer of ceramic and/or metal is in this manner obtained. This has particular applicability for example in the case of applying a hardened metal load bearing layer to prosthetic joints or in applying a wear resistant ceramic layer to the surfaces of refractory equipment used in foundrys.

The present invention will now be described further with reference to the following non-limiting examples.

### EXAMPLES

### Example 1

### Gelation of Chitosan with DHF

The gelation by cross-linking of an aqueous chitosan/2,5-dimethoxy-2,5-dihydrofuran (DHF) system has been rheologically examined as a function of temperature (40-98° C.), pH (0.9-3.9) and DHF concentration (1.0-10×10⁻² mole dm ³). The resulting findings can be summarised as follows:

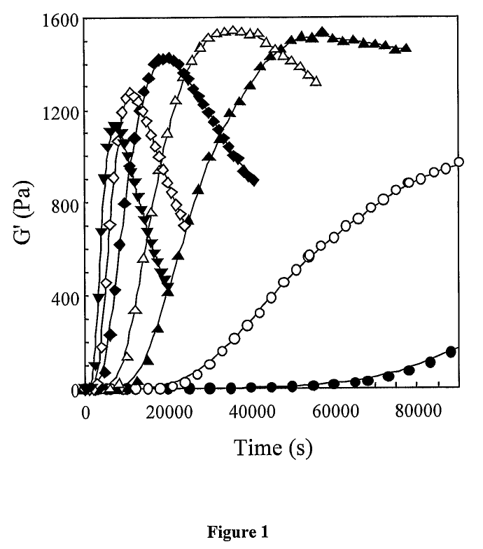

(1) The delay time prior to gelation decreases, and the rate of gelation increases as a function of rising temperature. The shear modulus versus time behaviour indicates that the mechanical strength of the gel initially increases then diminishes. These findings can be justified in terms of the competition between a butenedial-driven cross-linking reaction and gradual protolytic depolymerisation of chitosan. (See FIG. 1.)

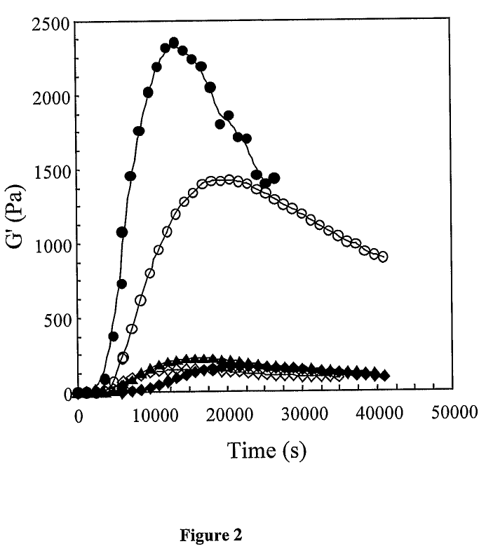

(2) At pH≦2.1, both the rate of gelation and the magnitude of the maximum shear modulus increase as a function of decreasing pH. In addition, the time at which the maximum shear modulus occurs is lower for the more acidic chitosan/DHF solutions. At pH>2.1, however, more complex behaviour is observed, and can be attributed to a gradual increase in pH (and associated decrease in chitosan solubility) as the conversion of DHF into butenedial progresses. (See FIG. 2.)

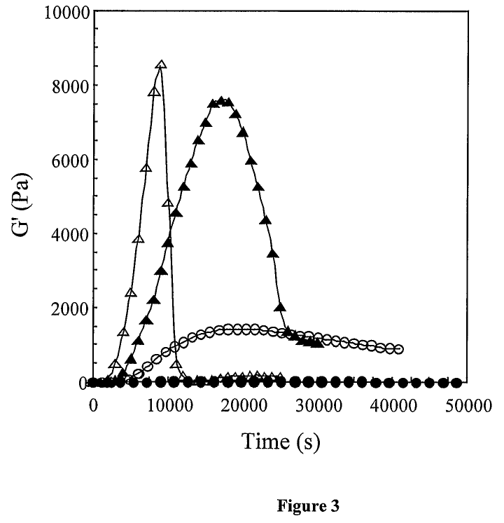

(3) The rate of gelation and magnitude of the maximum shear modulus increase as a function of rising DHF concentration. Such results are consistent with an increase in the rate of DHF conversion into butenedial, leading to a corresponding increase in the rate and extent of gelation. (See FIG. 3.)

### Example 2

### Change in Rheological Behaviour of Suspension During Gelation

A high purity α-alumina powder (AKP-30) was obtained from Sumitomo Corporation (Japan). It possessed a BET surface area of 7 m² gel, a mean particle diameter of 0.3 μm and a density of 3.97 g cm⁻³. A high molecular weight chitosan was purchased from Fluka BioChimika (Switzerland). It had a molecular weight of 2×10⁶ and a degree of de-acetylation (DD) of approximately 87 percent (Berthold, et al. 1996). The DD is an indicator of the proportion of hydrophilic (de-acylated) amine groups to hydrophobic acetamide moieties on the chitosan chains, with a high DD favouring good aqueous solubility to form low viscosity solutions. Cis/trans 2,5-dimethoxy-2,5-dihydrofuran (DHF) was obtained from Tokyo Kasei. The pH of all solutions and suspensions was adjusted using analytical grade hydrochloric acid and sodium hydroxide (both from Ajax Chemicals, Australia). All water used in this study was of Milli-Q grade (conductivity ≈10⁻⁶ μm⁻¹ at 20° C.).

Aqueous alumina suspensions with solids concentrations of 59 vol % were prepared by ultrasonication under acidic conditions using a Branson 450 sonifier equipped with a 0.75 inch horn. The sonifier was operated at a frequency of 20 KHz, with the power output maintained at approximately 90 percent of the limiting power (350 W). The samples were then slowly tumble-mixed for several hours prior to use.

Chitosan was initially solubilised separately from the preparation of alumina. Chitosan solutions were prepared by slowly tumble-mixing known quantities of the polysaccharide in appropriate volumes and concentrations of aqueous HCl. They were used within 12 hours of preparation in order to minimise the possibility of protolytic chitosan decomposition.

Aqueous alumina/chitosan/DHF samples for rheological analysis were prepared by mixing appropriate quantities of 59 vol % alumina suspensions, concentrated (≈2.5 wt %) chitosan solutions and pure DHF (transferred via a microsyringe). The final suspensions contained 45 vol % alumina, a solution chitosan concentration of 1.0 wt %, and solution DHF concentrations in the range of 20-200 millimole dm⁻³ (mM).

Small amplitude dynamic oscillatory measurements were performed in a cone-and-plate geometry using the ‘Oscillation Strain Control’ function of a Stresstech Rheometer (RheoLogica Instruments, Sweden) in combination with a 4°, 30 mm cone and a concentric cylinders elevated temperature cell (CCE). Evaporation was prevented by coating the alumina/chitosan/DHF samples with a layer of high viscosity (5000 centipoise) silicone oil and sealing the sample-holding region with an insulated cover.

The results of such rheological measurements are presented in FIG. 5 for suspensions at pH 2.2 with 100 mM concentration of DHF measured at various temperatures between 20 and 98° C. This figure illustrates that at room temperature the suspension does not gel and that increasing the temperature increases the rate of gelation as well as showing the final gelled modulus of the suspension. FIG. 6 demonstrates that the gelation behaviour is a complex function of the suspension pH for various pH values of suspensions tested at 80° C. with 100 mM DHF. FIG. 7 demonstrates that the stiffness of the gelled suspension as well as the rate of gelation will be increased by increasing the concentration of the cross-linking agent DHF in suspensions tested at pH 2.2 and 80° C.

### Example 3

### Analysis of Viscosity Variation with pH

A suspension was prepared containing 45 vol % alumina, a solution chitosan concentration of 1.0 wt %, as described in Example 2. The viscosity of the suspension was measured using the ‘Viscometry’ function of the Stresstech rheometer, again in a cone-and-plate geometry as in Example 2. As all viscometry measurements were performed at 20° C., evaporation was not found to affect the results obtained over the experimental time-frame. The use of silicone oil was therefore not deemed to be necessary. FIG. 4 is a plot of viscosity verses shear rate for suspensions at 20° C. at various pH values from 1.1 to 4.5. This figure indicates that at room temperature the suspension is slightly shear thinning but the viscosity is relatively low. The behaviour of the suspension is liquid-like and it is pourable and injectable.

One hundred millimole dm⁻³ (mM) DHF was added to the suspension. The suspension was allowed to mix for between 2 and 8 hours. The addition of the DHF and mixing did not significantly affect the rheological behaviour of the suspension.

### Example 4

### Preparation of Flexible Gelled Material Sheets

An alumina slurry having the following composition (wt %):

| | |
|---|---|
| Polyvinyl alcohol (Celvol 203S) | 3.0 |
| Water (Milli-Q grade) | 17.2 |
| HCl | 0.3 |
| Polyethylene glycol (M.W. = 1000) | 2.2 |
| Glycerol | 6.1 |
| Alumina (AKP-30) | 71.2 |
| 1-Octanol | 0.001 |

was prepared in the following manner:

1/ A 15 wt % solution of polyvinyl alcohol (Celvol 203S, Celanese Chemicals) was prepared by stirring the polymer in de-ionized cold water for a short period of time.

2/ To 54.0 g of the Celvol 203S solution was added 6.0 g of polyethyleneglycol (Sigma Chemicals, Av. Mol. Wt 1,000). The mixture was stirred for several minutes to dissolve the solid.

3/ Aqueous HCl (1.97 ml, 36 wt %, A.R., Ajax Finechemicals) was then added to the solution with stirring.

4/ A 25 ml aliquot of the acidified polymer solution was then transferred into a sample bottle and 81.2 g of α-alumina powder (AKP-30, Sumitomo Corporation) was mixed in manually.

5/ The suspension, in the sealed sample bottle, was then sonicated in a bath for several hours and tumble mixed overnight to give an homogeneous slurry.

6/ Glycerol (5.5 ml, Ajax Finechemicals, A.R.) and 1-octanol (0.17 ml, Ajax Chemicals, L.R.) were then added to the slurry followed by further tumble mixing.

7/ The slurry was then transferred to a round bottomed flask and de-gassed, using a vacuum pump, for 30 seconds.

8/ A small amount of slurry, without added cross-linker, was spread over silicon coated mylar tape using a flat blade to give an approximate slurry thickness of 0.5 mm. The tape was covered with Perspex to avoid solvent evaporation.

9/ To the remaining slurry in the flask (67.2 g) was added 2,5-dimethoxy-2,5-dihydrofuran (DHF) (0.4 ml, Aldrich Chemical Company).

10/ The mixture was stirred for several minutes and then cast on silicon coated mylar tape and also on a plain ceramic tile in an identical manner as previously described. The cast slurry was covered with Perspex to avoid solvent evaporation. After standing overnight at room temperature, the Perspex covers were removed from all of the tapes. The tapes to which DHF was added had undergone a significant amount of syneresis indicating that cross-linking had occurred. They were flexible and strong and were peeled from the substrate whilst completely wet without tearing or permanent deformation. Upon subsequent drying, a strong and flexible tape was produced which could be repeatedly rolled and unrolled without permanent warping or cracking.

The slurry without added DHF had not set at all. It was allowed to dry for one day at room temperature. A tape was formed which cracked severely when peeled from the substrate.

This example demonstrates that, in comparison to conventional tape casting, the application of cross-linking, for the production of ceramic tapes/sheets, produces superior products.

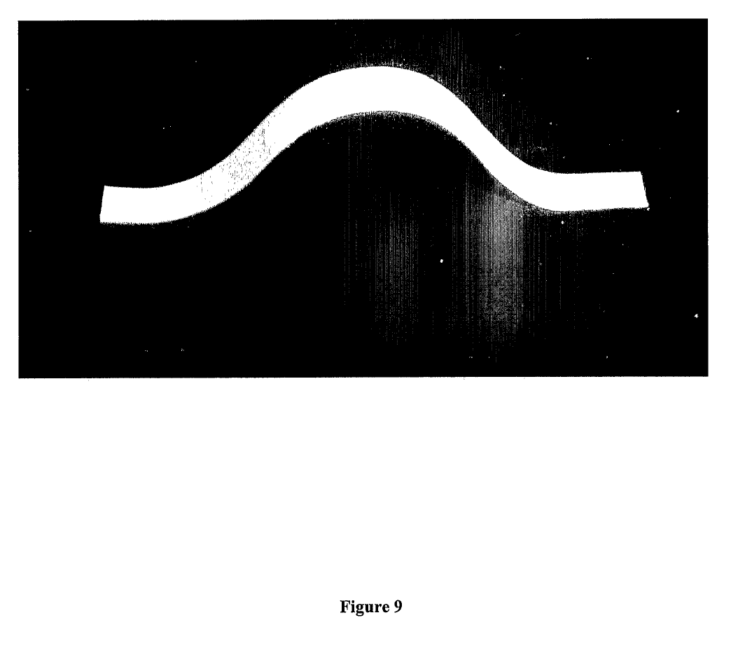

FIG. 9 shows a flexible and strong tape produced by the cross-linking method described in this patent specification.

### Example 5

### Effect of Crosslinker Concentration

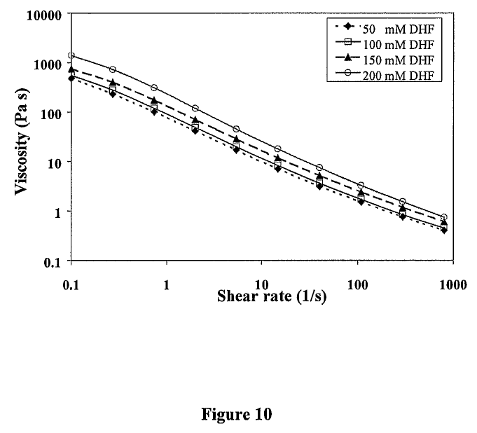

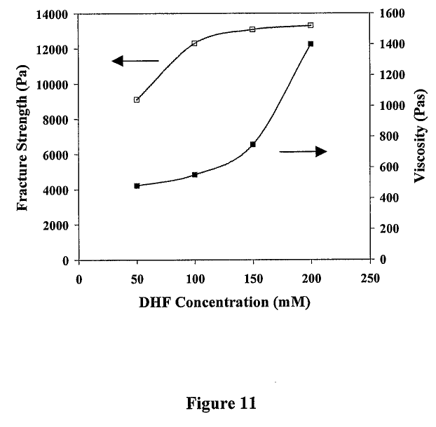

Suspensions were produced with 45 V % AKP-30 alumina, a solution concentration of 1 wt % chitosan and different concentrations of DHF following the procedure described in Example 2. A low molecular weight chitosan (150,000 g/mole) was used instead of the high molecular weight chitosan used in previous examples. The viscosity of the alumina-chitosan-DHF suspensions was measured using a Bohlin CVO constant stress rheometer. The measurements were performed at 25° C. using a 4°, 40 mm cone and plate geometry. As shown in FIG. 10, the viscosities of all suspensions were found to be shear thinning, indicative of a slight degree of gelation of the biopolymer even prior to heat treatment. The increase of the concentration of the crosslinker (DHF) was found to increase the viscosity at all shear rates by approximately tripling the viscosity with an increase of 50 to 200 mM DHF as indicted in FIG. 11. The increase of viscosity is most likely due to the increased degree of crosslinking of the biopolymer with the greater concentrations of DHF.

### Example 6

### Effect of pH

The pH of the suspensions has a complex effect on the chemical interactions between the alumina particles, chitosan and DHF(⁹). As pH is decreased both alumina and chitosan become increasingly positively charged. As the charge on chitosan increases its solubility increases. At pH above about 5.5 or 6 chitosan is not soluble because it has very little charge. At elevated temperature DHF decomposes to produce butenedial which is the active crosslinking agent. Both a high concentration of H⁺ (low pH) and an increased temperature are required for DHF to produce butenedial(⁶).

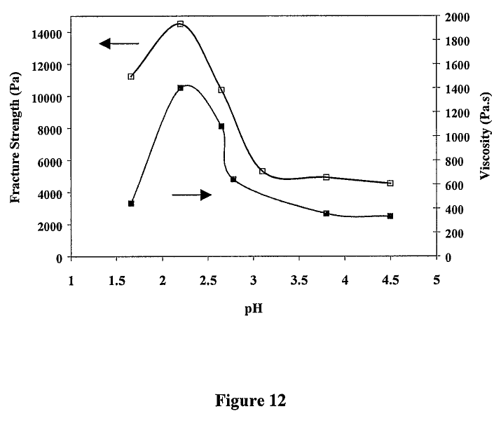

Suspensions were produced with 45 V % alumina, a solution concentration of 1 wt % chitosan and 200 mM DHF as described in Example 2 except that a low molecular weight chitosan (150,000 g/mole) rather than high molecular weight chitosan was used. The viscosity of the suspensions and the strength of the gelled body were measured as described in example 5 for different pH values of the suspensions. FIG. 12 shows the results of the viscosity and strength measurements at different pH values from 4.5 to 1.5. The viscosity is a maximum at about pH 2.2 and decreases at both higher and lower pH values. A similar trend can be observed in FIG. 4 of Example 3 for suspensions containing no DHF. Although the viscosity of the suspension decreases as pH is increased the suspension appears to be less homogeneous. At pH above about 3, there appear to be chunks of undissolved chitosan in the suspension. The lower amount of dissolved polymer in the solution as well as the reduced activity of the crosslinking agent (and correspondingly less crosslinking) result in the decreased viscosities at higher pH. Unfortunately the chunks of undissolved chitosan in the suspension act as defects in the gelled body (and in the final fired component) which reduce the strength and reliability of the body. FIG. 12 clearly shows the decrease in the strength of the gelled bodies as pH increases. The decreased strength is believed to be due to the defects created by the insoluble chitosan chunks as well as the reduced level of polymer crosslinking due to the reduced activity of DHF at higher pH values. The reason for the decrease in both viscosity and strength observed at pH 1.5 is currently unknown although it may be related to the high ionic strength of the very low pH condition. The greatest strength gelled bodies are produced from pH 2.2 suspensions, but there may be circumstances when the reduced viscosity of the pH 1.5 suspensions will be beneficial such as when filling complex shaped moulds.

### Example 7

### Effect of Time of Heat Treatment

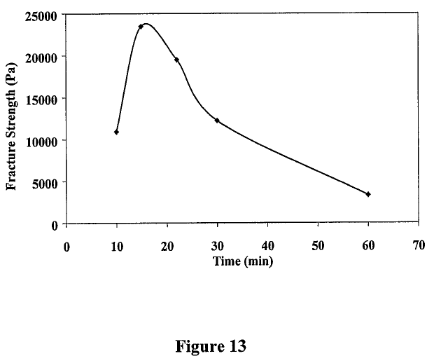

Based on the initial rheological measurements of the alumina/chitosan/DHF system (see FIGS. 5 through 8) it was believed that increased periods of gelation up to about 5 hours would only produce stronger bodies. Surprisingly as shown in FIG. 13, the greatest strength bodies were produced after only 15 minutes of gelation. Shorter times were insufficient for enough crosslinking to occur to produce solid like bodies. Longer times produced gelled bodies that were slightly discoloured. The alumina suspensions are bright white, as were the bodies produced after 15 minutes heat treatment. Bodies produced with longer heat treatment times were slightly tan in colour. The tan colour becoming darker with longer heat treatment times. Such behaviour is most likely due to the thermal degradation of chitosan, which weakens the network strength of the parts. Another factor that might contribute to the drop in strength of the bodies is syneresis. Syneresis is the contraction of the gel and the squeezing out of free water bound from within the gel structure. This phenomenon was observed in the samples with heating periods greater than 10 minutes, which indicates the presence of highly crosslinked networks. Naturally, with an increased number of crosslinks, the gelled bodies become stiffer and less deformable.

### Example 8

### Effect of Temperature of Heat Treatment

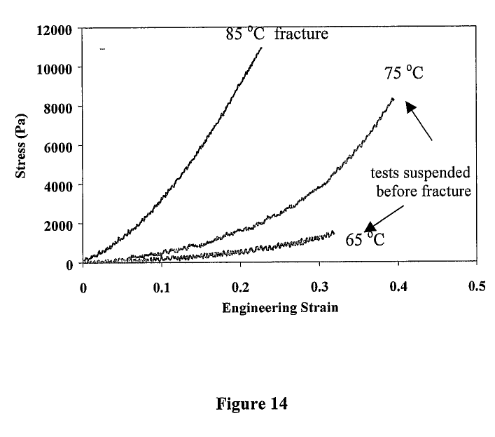

The decomposition rate of DHF into butenedial is strongly dependent upon temperature(⁶), Since butenedial is the active molecule in chitosan crosslinking process, an increase in the rate of DHF decomposition will lead to an increase in the level of butenedial molecules and consequently, formation of stronger gelled bodies. Cylindrical bodies were produced and mechanically tested as described in example 5. In all cases the bodies were cooled to room temperature before de-moulding and mechanical testing. At heat treatment temperatures below 65° C., the wet gelled bodies were sticky and unable to hold their shapes. As a result, the components produced under these conditions at low heat treatment temperatures were unsuitable for mechanical testing. FIG. 14 shows the results of the mechanical tests of bodies heat treated at between 65 and 85° C. Bodies produced by heat treatments at 65 to 75° C. were extremely flexible and could be deformed to a great extent without fracturing. At these treatment temperatures much of the deformation was permanent. By increasing the operating temperature, the gelation process completed after a shorter period of time and samples became relatively more rigid, allowing successful mould removal and handling at heat treatment temperatures of 85° C. and above.

### Example 9

### Zirconia Suspension

A high purity Zirconia powder (TZ-O) was obtained from Tosoh Corporation (Japan). It possessed a surface area of 15.9 m²/g, with a crystalline size of 250 Å. A high molecular weight chitosan was obtained from Fluka Biochimika (Switzerland). It has a molecular weight of 2×10⁶. Cis/trans 2,5-dimethoxy-2,5-dihydrofuran (DHF) was obtained from Tokyo Kasei. The pH of all solutions and suspensions was adjusted using analytical grade hydrochloric acid and sodium hydroxide. All water used in this study was of triple distilled grade.

Chitosan stock solution was made at 2.0 weight %, in triple distilled water. The chitosan powder was mixed into water, with an overhead mixer, while the pH of the solution was constantly adjusted to 2.0, with appropriate volume of aqueous HCl. The solutions were used within 24 hours of preparation.

Aqueous zirconia/chitosan/DHF samples for rheological analysis were prepared by mixing appropriate quantities of zirconia, chitosan solutions and pure DHF (transferred via micropippette) with a spatula. The final suspension contained 30 vol % Zirconia, chitosan concentration of 1 wt %, and solution DHF in the range of 20-100 millimole dm⁻³ (mM).

Small amplitude dynamic oscillatory measurements were performed in a cone-plate geometry using the ‘Oscillation function’ of the Carri-med Constant Stress Rheometer with a 4 cm, 1 59° cone. Evaporation was prevented by sealing the Zirconia/chitosan/DHF sample with a layer of paraffin oil.

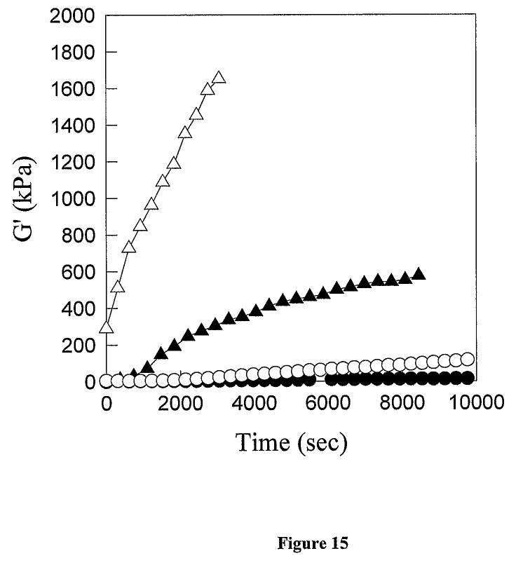

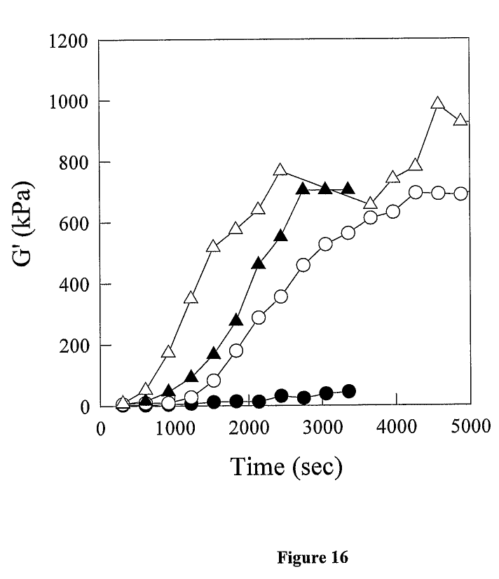

The results of such Theological measurements are presented in FIG. 15 for suspensions at pH 2.2 with 80 mM concentration of DHF measured at various temperatures between 20 and 98° C. This figure illustrates that at room temperature, the suspension does not gel and that increasing the temperature increases the rate of gelation and the final shear modulus of the suspension. FIG. 16, demonstrates that the shear modulus and rate of gelation increased with concentration of DHF.

### Example 10

### Silicon Nitride Suspension

Silicon nitride powder (SN-E03) was obtained from UBE INDUSTRIES LTD (Japan). It possessed a surface area of 3.2 m²/g. A high molecular weight chitosan was obtained from Fluka Biochimika (Switzerland). It has a molecular weight of 2×10⁶. Cis/trans 2,5-dimethoxy-2,5-dihydrofuran (DHF) was obtained from Tokyo Kasei. The pH of all solutions and suspensions was adjusted using analytical grade hydrochloric acid and sodium hydroxide. All water used in this study was of triple distilled grade.

Chitosan stock solution was made at 2.0 weight %, in triple distilled water. The chitosan powder was mixed into water, with an overhead mixer, while the pH of the solution was constantly adjusted to 2.0, with appropriate volume of aqueous HCl. The solutions were used within 24 hours of preparation.

Aqueous silicon nitride/chitosan/DHF samples for rheological analysis were prepared by mixing appropriate quantities of silicon nitride, chitosan solutions and pure DHF (transferred via micropippette) with a spatula. The final suspension contained 30 vol % silicon nitride, chitosan concentration of 1 wt %, and solution DHF in the range of 20-100 millimole dm⁻³ (mM).

Small amplitude dynamic oscillatory measurements were performed by cone-plate geometry using the ‘Oscillation function’ of the Carri-med Constant Stress Rheometer with a 4 cm, 159° cone. Evaporation was prevented by sealing the silicon nitride/chitosan/DHF sample with a layer of paraffin oil.

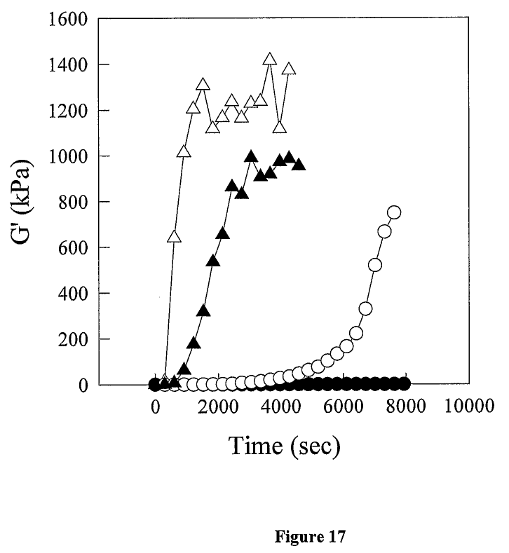

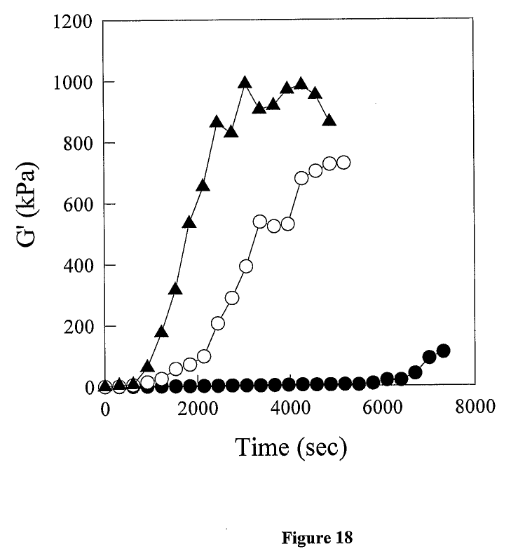

The results of such rheological measurements are presented in FIG. 17 for suspensions at pH 2.0 with 80 mM concentration of DHF measured at various temperatures between 20 and 98° C. This figure illustrates that at room temperature, the suspension does not gel and that increasing the temperature increases the rate of gelation and the final shear modulus of the suspension. FIG. 18, demonstrates that the shear modulus and rate of gelation increased with concentration of DHF.

### Example 11

### Syneresis of Gelled Body

### Materials and Methods

A high purity α-alumina powder (AKP-30 Sumitomo, Japan), with a density of 3.97 g/cm³ and a mean particle size (d₅₀) about 0.33 microns was used for this work. The cross-linking agent precursor, 2,5-dimethoxy-2,5-dihydrofuran (DHF), was obtained from Sigma-Aldrich. The formulations for aqueous tape casting contained 60-75 wt % alumina, 17-30 wt % water, 3-5 wt % polymer, 3-9 wt % plasticiser, <1 wt % aqueous acid, <0.5 wt % de-foaming agent and <500 mM of DHF (relative to volume of water). One specific formulation adopted was that of Example 4. The slurries were prepared using ultrasonic dispersion and overnight mixing. The shear viscosity was measured as a function of shear rate using a Carri-Med controlled stress rheometer, CSL, equipped with a 2°, 40 mm diameter cone and plate geometry. The slurries were de-gassed and then cast as <0.5 mm films on glass substrates. The glass substrate had raised lips (about 0.3 mm) on two edges. About 10 ml of the suspension was placed on the central portion of the glass and spread using a plastic spatula spanning the two raised lips. In this way, tapes of about 0.3 mm thickness±0.1 mm were produced. Due to the crude apparatus used (compared to a doctor blade apparatus) the control of tape thickness was not possible. Some tapes were cast without the cross-linking agent. The cast tapes were sealed in a container, maintained at 100% relative humidity and allowed to cross-link, at room temperature for 24 hours. The tapes were then dried in ambient air at room temperature for 48 hours before removal from the substrate. After removal from the substrate the tapes were further dried at 110° C. for two hours before being sintered at 1550° C. for two hours.

### Results and Discussion

### (a) Viscosity

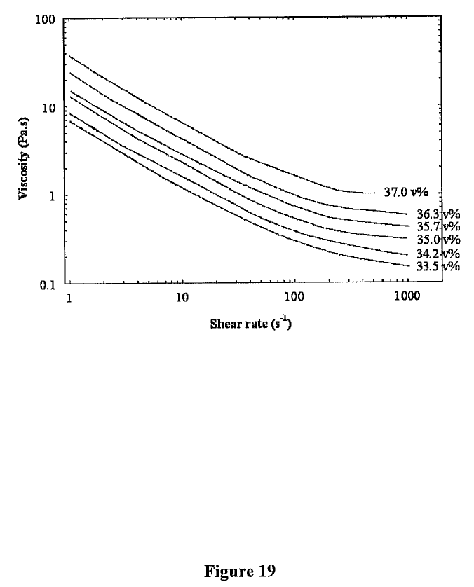

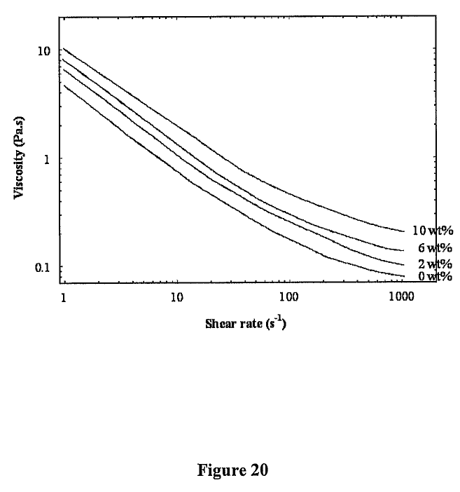

FIG. 19 shows the viscosity of the alumina tape casting suspensions over a range of solids concentrations ranging from 33.5 to 37 volume percent solids. The viscosities are shear thinning and approach a Newtonian plateau at high shear rate. As expected the increase in particle concentration results in increase in shear viscosity. FIG. 20 is an example of how the increased plasticiser (glycerol) concentration increases the viscosity of the suspensions. Other experiments not shown here indicate that the viscosity of the suspensions increases with the concentration of poly vinyl alcohol from 2 wt % to 4 wt %. Maintaining a low viscosity is important for processing using the doctor blade process. At the same time, maintaining a high volume fraction of solids is important to minimise shrinkage, distortion and fracture during firing.

### (b) Cross-Linking

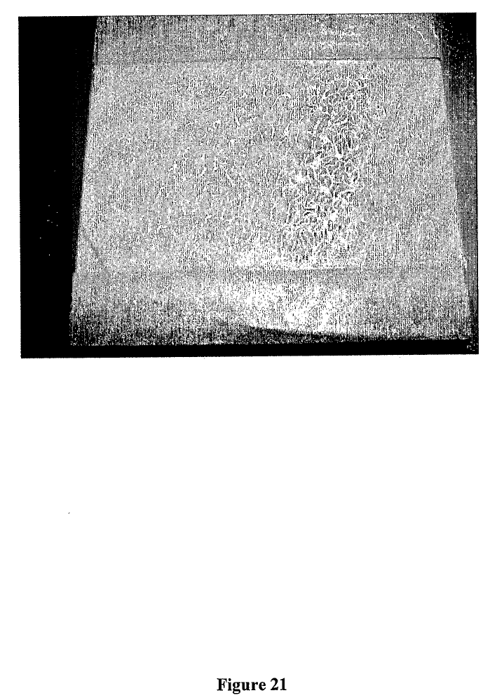

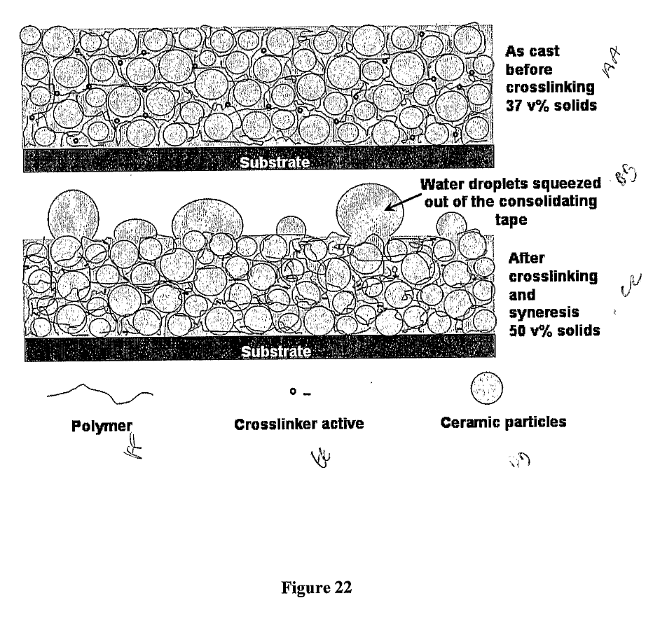

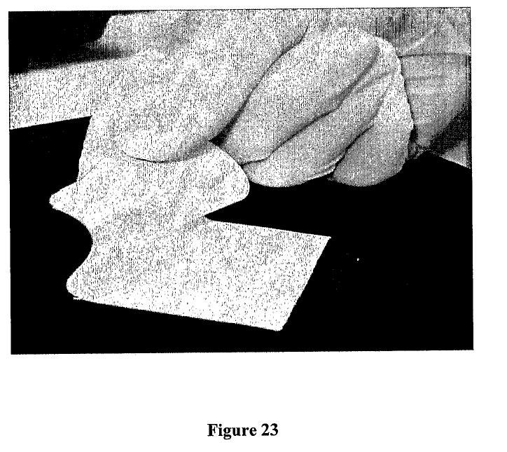

Tapes were cast and cross-linked as described above. Increasing the polymer concentration from 2 to 4 wt % increased the mechanical integrity of the tapes as judged by the ability to remove the tape form the substrate after drying. During the cross-linking, small water droplets formed on the surface of the tape (see FIG. 21.) No droplets were observed when no cross-linking agent was used. The droplets are the result of syneresis of the tape in the direction orthogonal to the substrate. Syneresis is shrinkage of the polymer network that occurs during gelation. The shrinkage consolidates the wet tape and squeezes water out from between the particles and gel structure. The reduction in tape thickness during cross-linking is difficult to characterise due to the crude casting technique, but is approximately 10 to 30% in the direction orthogonal to the substrate. This shrinkage and expulsion of water is believed to increase the solids concentration of the tape from the slurry concentration (37 vol %) to a green density of about 50 to 55 vol % solids based on shrinkage measurements during firing (see next section). FIG. 22 schematically shows how the syneresis results in consolidation of the particle network. No shrinkage was noted along the directions parallel to the surface during cross-linking due to constraint of the tape by the substrate. After 24 hours of cross-linking in humid environment the tape is dried at room temperature in ambient air for 48 hours. The tape is then removed by peeling from the substrate. FIG. 23 shows the flexibility and integrity of the tapes after removal from the substrate.

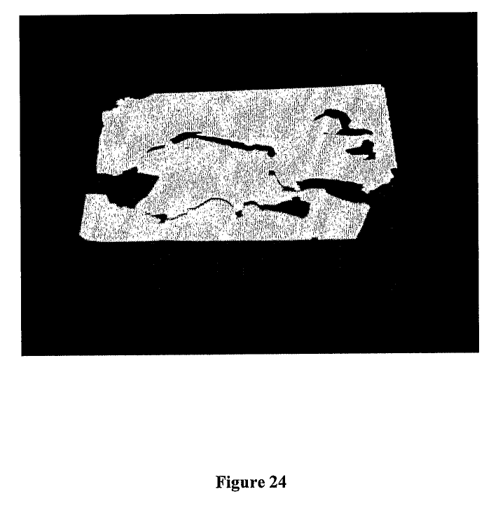

Tapes cast without cross-linking agent, but processed in the same way as described above (including 24 hours in humid environment) were found to be very difficult to remove from the substrate after 48 hours of air drying. FIG. 24 demonstrates how the tape tears during removal from the substrate when it is not cross-linked. The improved processability of the cross-linked tapes is believed to be due to the improved mechanical behaviour of the cross-linked tapes such as higher strength and greater strain to failure.

### (c) Densification

After drying at 110° C. for 2 hours, less than 0.5% linear shrinkage was observed. The tapes were then sintered at 1550° C. for 2 hours. The tapes reached densities of between 3.86 and 3.95 g/cm³ (97 to 99.5% of full density). There was no clear trend between density and initial suspension solids loading. The linear shrinkage during firing in the directions parallel to the substrate was between 17 and 20%. Again, there was no clear trend between shrinkage and suspension solids concentration. Although it was difficult to measure accurately, the shrinkage during firing in the direction orthogonal to the substrate was about 20% as well. The linear shrinkage and final density calculations suggest that the dry green density of the tapes was between about 50 and 55 vol % solids. This is significantly greater than the solids content of the suspension (37 vol %). Since less than 0.5% linear shrinkage was noted during drying, it must be concluded that the majority of the consolidation occurred due to the syneresis of the polymer network during and after cross-linking. The additional consolidation of the wet green tape during cross-linking is important in producing higher green densities so that fired ceramics that reach full density can be produced from relatively low solids content slurries.

### CONCLUSIONS

The addition of a cross-linking agent to an aqueous tape casting formulation allows for the strengthening of the wet tape before the drying stage. The increased strength of the tape during drying and removal from the substrate reduce the occurrence of tearing and cracking during these process steps. The formulation produces suspensions with low viscosity suitable for tape casting and can be sintered to >97% of theoretical density. The syneresis of the polymer gel during and after cross-linking consolidates the tape solids concentration from 37 v % solids to over 50 v % solids. This additional consolidation is of assistance in producing fired ceramics with densities very near full theoretical. Relatively low viscosity slurries can be used because the suspension volume fraction is kept relatively low. The additional consolidation during the cross-linking stage is mainly responsible for the increased green density resulting in high fired densities. Although in this example relatively slow cross-linking and drying (at room temperature) was adopted, it is possible to reduce the time for each of these process steps in full scale production. The cross-linking can be completed in about 15 minutes at 70° C. in a humidity controlled environment and drying can be completed at similar temperature much more rapidly.

### Example 12

### Effect of solid loading using PVAs 203S and 205S

A comprehensive study on the tape casting of yttria stabilised zirconia (YSZ) powders was undertaken. The YSZ powder (10YSZ-15A) was obtained from Ceramic Fuel Cells Limited. With respect to the YSZ powder, the effect of solid loading on tape casting using PVA's 203S and 205S was investigated.

Using 4 wt % PVA 203S, slurries having solid loadings of 60, 62, 64, 66, 68 and 70 wt % were prepared. The concentration of the other constituents were kept constant at 1.2 wt % conc. HCl, 3 wt % glycerol, 3 wt % PEG(400), 0.2 wt % 1-octanol and the remaining difference in water (100 g total weight of slurry).

It was noted that, as the solid loading increased, the pH of the slurries also increased from 0.9 (60 wt %) to 1.7 (68 wt %). This can be attributed to the presence of acid reactive yttria, which is one of the constituents of the YSZ ceramic powder. Thus, an increase in the YSZ solid loading results in a higher concentration of yttria in the slurry, which leads to a corresponding increase in the pH when a given amount of acid is used.

It was found that, the viscosity of the slurries increased exponentially with solid loadings above 60 wt %. The 60 and 62 wt % slurries had relatively low viscosities, of 8.9 and 10.5 Pa·s (at shear rate of 1 s⁻¹) respectively, which allowed easy de-gassing. The 70 wt % slurry could not be prepared using the above formulation as it was far too viscous and inhomogeneous. A 70 wt % formulation was prepared using less PVA (3.5 wt %), glycerol (2.0 wt %) and PEG (2.0 wt %).

Cross-linking agent (DHF) was added at a concentration of 300 mM (with respect to water present) and the tapes were covered and cross-linked at room temperature for 26 hours. The 60 and 62 wt % slurries produced the smoothest and most flexible tapes (62 wt % marginally the best). Also, it became evident that when the pH is higher than ˜1.5, the PVA cross-links much more slowly and produces tapes which, if formed at all, are very weak after 26 hours.

The green density of the tapes, when dried in air for several days, was typically between 59-65 wt % of theoretical. Tapes dried in an air oven at 110° C. for 3 hours, and then to constant weight at 150° C., had densities ranging between 66-71% of theoretical. When sintered at 1550° C. for two hours, all of the tapes had densities ranging between 100-101% of theoretical. Linear shrinkage of tapes, from the oven drying stage and after the sintering stage, ranged between 20-25%. There appeared to be no correlation between solid loading and density of the tapes in either the “green” or sintered states. However, all of the tapes displayed some degree of warping, which was most likely caused by uncontrolled initial drying in air.

Experiments, using PVA 205S, were performed in an identical manner to those using PVA 203S. However, due to time constraints the tapes produced were not dried or sintered. As expected, the viscosity of the slurries increased with polymer loading and slurries containing PVA 205S had higher viscosities than their respective analogues containing PVA 203S. Tapes containing PVA 205S appeared to cross-link much faster, and more strongly, than those containing PVA 203S. Slurries having solid loadings greater than 62 wt % appeared to be too viscous for adequate de-gassing and, as such, produced tapes which were visibly inferior in texture.

### Example 13

### Effect of Polymer Loading Using PVAs 203S and 205S

The effect of polymer loading using PVA 203S and PVA 205S was also investigated. Slurries having a loading of 60 wt % of YSZ, 1.2 wt % conc. HCl, 3 wt % glycerol, 3 wt % PEG(400), 0.2 wt % 1-octanol and either 3.5, 4.0 or 4.5 wt % PVA 203S or 3.5, 4.0 or 4.5 wt % PVA 205S were prepared and cross-linked using a DHF concentration of 300 mM. The highest viscosity slurry was that containing 4.5 wt % PVA 205S (14.2 Pa·s at shear rate of 1 s⁻¹). However, the viscosity of this slurry was still low enough to enable adequate de-gassing before casting.

The “green” densities of the air dried tapes were between 58-63% of theoretical after air drying and 66-68% of theoretical after oven drying to constant weight at 150° C. A cursory glance at the dried “green” densities suggests that they may be fractionally high. But theoretical calculations show that that is not the case. For example, the maximum theoretical density of the “green” body can be calculated in the following way:
The density of the YSZ powder is 5.5 g/ml.
The density of Celvol PVA dry polymer is 1.27-1.31 g/ml and that of glycerol is 1.26 g/ml. Hence, the density of the region between the YSZ particles is ˜1.27 g/ml ((glycerol and polymer).
Assuming that randomly packed spheres have a maximum packing density of 64 wt %, the maximum theoretical “green” density of the tape is:

[(5.5×0.64)+(1.27×0.36)] g/ml=3.98 g/m.
This is ˜72% of the theoretical density after sintering (5.5 g/ml).

Considering that the tapes are cast from slurries having solid loadings of ˜30-35 vol %, the high “green” densities suggest that considerable densification of the tapes takes place during the cross-linking reaction alone, regardless of the initial solid loading of the slurries. This result is significant from a tape casting point of view.

After sintering, the final tapes had densities ranging between 98-101% of theoretical. There appeared to be no correlation between the concentration and type of PVA used and the density of the tapes produced.

### Example 14

### Effect of pH on Slurry Formation and Cross-Linking

The effect of pH on slurry formulation and cross-linking was also studied. Slurries having a loading of 60 wt % YSZ, 3 wt % glycerol, 3 wt % PEG(400), 0.2 wt % 1-octanol, 4.0 wt % PVA 203S and varying amounts of conc. HCl were prepared and cross-linked using a DHF concentration of 300 mM.

Overall, it was established that decreasing slurry pH (increasing acidity) leads to increasing slurry viscosity. As noted above, the rate of cross-linking was very slow, at room temperature, for slurries having pH readings above 1.5.

There was no noticeable trend between slurry pH and the green densities of air dried (58-63% of theoretical) and oven dried tapes (65-68% of theoretical)

### Example 15

### Effect of Plasticiser Addition

The effect of adding glycerol and PEG(400) as plasticisers was also investigated. Slurries having a loading of 60 wt % YSZ, 4.0 wt % PVA 203S, 1.2 wt % of conc. HCl, 0.2 wt % 1-octanol and either 0 wt % of plasticiser, 3 wt % each of glycerol and PEG(400), 6 wt % glycerol or 6 wt % PEG(400), were prepared and cross-linked using a DHF concentration of 300 mM.

All of these slurries had low viscosities suitable for adequate de-gassing (between 8-12 Pa·s at a shear rate of 1 s⁻¹). The tape prepared with no plasticiser had minimal flexibility and easily cracked when bent. The tape prepared using 6 wt % PEG(400) was somewhat flexible, but still quite rigid and could not be bent significantly without cracking. The tape prepared using 6 wt % glycerol was the most flexible and was very smooth compared to all of the other tapes with the exception of the 3 wt % glycerol/3 wt % PEG(400) tape, which was as smooth but not as flexible.

### Example 16

### Use of Alumina as Ceramic Powder

Work performed on the tape casting of alumina, under similar conditions adopted for YSZ as reported in example 12 gave very similar results to that obtained for YSZ. The densities of the alumina tapes after sintering were between 99-100% of theoretical.

This is an excellent result and is well within the required range.

### Example 17

### Formulation Examples

The following is a summary of some of the formulations tested:

Formulation A—60 wt % YSZ, 4.5 wt % PVA 203S, 1.2 wt % conc. HCl, 6.0 wt % glycerol, 0.2 wt % 1-octanol, 28.1 wt % water. 300 mM of DHF was added.

Tape was cast at 600 micron thickness on cellulose acetate. It cross-linked at room temperature overnight to give a well formed tape which could be easily peeled from the substrate.

Formulation B—60 wt % YSZ, 4.5 wt % PVA 205S, 1.2 wt % conc. HCl, 6.0 wt % glycerol, 0.2 wt % 1-octanol, 28.1 wt % water. 300 mM of DHF was added.

Microscopic examination of the slurry before casting showed many agglomerates present. Since these slurries had been processed for several weeks prior to casting, this result suggests that sonication and tumble mixing are ineffective at dispersing the ceramic powder.

Tape was cast at 600 micron thickness on mylar. It cross-linked at room temperature overnight to give a well formed tape which could be easily peeled from the substrate. The mylar substrate did not appear to be as good as the cellulose acetate because the slurry receded much more at the edges (about 0.5-1.0 cm) after casting and cross-linking. This tape looked much smoother than that obtained with formulation A.

Formulation C—60 wt % YSZ, 4.0 wt % PVA 205S, 1.2 wt % conc. HCl, 8.0 wt % glycerol, 0.2 wt % 1-octanol, 26.6 wt % water. 300 mM of DHF was added.

This slurry was milled using zirconia beads to the point where microscopic examination could not detect agglomerates.

Tape was cast at 600 micron thickness on mylar. It cross-linked at room temperature overnight to give a well formed tape which could be easily peeled from the substrate. This tape looked to be much better than those obtained with formulations A and B, most likely due to the milling.

Formulation D—60 wt % YSZ (Melox 10YSZ—002075), 4.5 wt % PVA 205S, 1.1 wt % conc. HNO3, 6.0 wt % glycerol, 0.2 wt % 1-octanol, 28.2 wt % water. 300 mM of DHF was added.

This slurry was milled using zirconia beads to the point where microscopic examination could not detect agglomerates.

Tape was cast at 250 micron thickness on cellulose acetate. It cross-linked at RT overnight to give a well formed tape, with minimal shrinkage in the horizontal plane. The tape could easily be peeled from the substrate.

### Example 18

### Effect on Cross-Linking of Microwave Heating

Work was performed on microwave cross-linking of PVA-YSZ tapes where cellulose acetate was used as the substrate. Although preliminary in nature, this work demonstrated that use of microwave heating can increase the cross-linking rate of the PVA-DHF system remarkably, and that cellulose acetate is an ideal substrate under these conditions. Tapes were shown to cross-link within 1-2 minutes of microwaving at the lowest setting of a microwave convection oven (total wattage of microwave oven unknown but most likely ˜1 Kw). However, all of the tapes had pitted surfaces due to water overheating to its boiling point.

Since the microwave oven was too powerful, even at the lowest setting, no further work was undertaken. Nevertheless, based upon these results, we believe it will be possible to quickly produce PVA-DHF tapes of acceptable quality, if the output of the microwave source can be controlled at appropriately low levels.

In the microwave heating experiments formulations of Celvol 205S were tested, which were identical to those used in example 17, with the exception that 100 mM of DHF was used instead of 300 mM. All of the tapes cross-linked very well when 100 Mm of DHF was used. The reason 300 mM of DHF was used for the initial tape casting work was that this quantity of DHF was required for tapes to cross-link relatively quickly at room temperature.

It is to be understood that the present invention has been described by way of example only and that modifications and/or alterations thereto, which would be apparent to a person skilled in the art based upon the disclosure herein, are also considered to fall within the scope and spirit of the invention, as defined in the appended claims.

### REFERENCES

1. Balzer, B., Hruschka, M. K. M., and Gauckler. L. J., J. Colloid and Interface Sci., 216, 379-386 (1999).
2. Berthold, A., Cremer, K., and Kreuter, J., “Preparation and Characterization of Chitosan Microspheres as Drug Carrier for Prednisolone Sodium Phosphate as Model for Anti-Inflammatory Drugs,” J. Control. Rel., 39, 17-25, (1996).
3. Braun, D. and Walter, E., Colloid and Polymer Science, 258(7), 795-801 (1980)
4. Chen, Y., Xie, Z Z Z, Yang, J., and Huang, Y., J. European Ceramic Soc., 19, 271-275 (1999).
5. German, R. M., Hens, K. F. and Lin, S.-T. P., “Key Issues in Powder Injection Moulding”, Am. Ceram. Soc. Bulletin, 70 [8] 1294-1302 (1991)
6. Hansen, E. W.; Holm, K. H.; Jahr, D. M.; Olafsen, K.; Stori, A., Polymer, 38, 4863-4871 (1997).
7. Lange, F. F., “Powder Processing Science and Technology for Increased Reliability”, J. Am. Ceram. Soc., 72 [1] 3-15 (1989).
8. Mangels, J. A., “Low Pressure Injection Moulding”, Am. Ceram. Soc. Bull., 73, 37-41 (1994).
9. Mathur, N. K.; Narang, C. K. J. Chem. Edu. 67, 938-942 (1990)
10. Pujari, V. K., Tracey, D. M., Foley, M. R., Paille, N. I., Pelletier, P. J., Sales, L. C.,
Willkens, C. A. and Yeckley, R. L., “Reliable Ceramics for Advanced Heat Engines”, Am. Ceram. Soc. Bulletin, 74 [4] 86-90 (1995).
11. Takeshita, M. and Kurita, S., “Development of Self Hardening Slip Casting”, J. Europ. Ceram. Soc., 17, 415-419 (1997).
12. R. E. Mistler and E. R. Twiname, “Tape casting, Theory and Practice”, The American Ceramic Society, 2000.
13. R. Moreno, “The Role of Slip Additives in Tape Casting Technology: Part 1—Solvents and Dispersants,” Am. Ceram. Soc. Bull., 71, 1521-31 (1992).
14. T. Chartier and A. Bruneau, “aqueous tape casting of alumina substrates”, J. Europ. Ceram. Soc., 12 243-247 (1993).
15. A. Kristoffersson and E. Carlstrom, “Tape casting of alumina in water with an acrylic latex binder”, J. Europ. Ceram. Soc., 17, 289-297 (1997).
16. F. Doreau, G. Tari, C. Pagnoux, T. Chartier and J. M. F. Ferreira, “Processing of Aqueous Tape-casting of alumina with acrylic emulsion binders”, J. Europ. Ceram. Soc., 18, 311-321 (1998).
17. Z. Yuping, J. Dongliang, J. and P. Greil, “Tape casting of alumina slurries”, J. Europ. Ceram. Soc., 20, 1691-1697 (2000).
18.1. Santacruz, C. A. Gutierrez, M. I. Nieto, R. Moreno, “Application of alginate gelation to aqueous tape casting technology”, Mater. Res. Bull., 37, 671-682 (2002).
19. B. Bitterlich, J. G. Heinrich, “Aqueous tape casting of silicon nitride”, J Europ. Ceram. Soc., 22, 2427-2434 (2002).
20. S. Mei, J. Yang and J. M. F. Ferreira, “The fabrication and characterisation of low-k cordierite-based glass-ceramics by aqueous tape casting”, J Europ. Ceram. Soc., 24, 295-300 (2004).
21. D. Hotza and P. Greil, “Aqueous Tape Casting Of Ceramic Powders”, Mater. Sci. Eng. A, 202, 206-217 (1995).

The disclosure of each of the publications referred to within this specification is included herein in its entirety, by way of reference.

1. A method of producing a sheet of flexible gelled ceramic and/or metallic containing material, comprising the steps of:
(a) combining water, ceramic and/or metallic powder, polymer, plasticiser, water soluble cross-linking agent precursor and optional further components to produce a mixture;
(b) applying the mixture to a suitable substrate to form a layer of desired dimensions;
(c) exposing the layer to conditions suitable for cross-linking to occur.

2. The method according to claim 1 comprising a further step of removing from the substrate a flexible gelled material obtained following step (c).

3. The method according to claim 1 comprising a further step of drying of a flexible gelled material obtained following step (c).

4. The method according to claim 1 wherein the polymer is selected from polymers having amide, amine, carboxylic acid and/or hydroxyl functionalities.

5. The method according to claim 1 wherein the polymer is selected from chitosan, polyvinylalcohol, gelatine, poly(allyl)amine, polyethylenimine, chitin, polyacrylic acid, polyvinylacrylate, polyacrylate, polyacrylamide, pectin, xanthan gum and mixtures thereof.

6. The method according to claim 1 wherein the water soluble cross-linking agent precursor is temperature activated.

7. The method according to claim 1 wherein the cross-linking agent precursor forms a multifunctional aldehyde upon temperature increase.

8. The method according to claim 1 wherein the cross-linking agent precursor forms a di-aldehyde upon temperature increase.

9. The method according to claim 1 wherein the cross-linking agent precursor is 2,5-dimethoxy-2,5-dihydrofuran (DHF).

10. The method according to claim 1 wherein the ceramic powder comprises one or more of alumina, zirconia, silica, titania, silicon nitride, silicon carbide and aluminium nitride.

11. The method according to claim 1 wherein the optional further components comprise one or more of binders, dispersants, chelating agents, surfactants, defoaming and/or wetting agents, salts, colouring agents, buffers, acids and alkali.

12. A sheet of flexible gelled ceramic and/or metallic containing material produced by a method according to claim 1.

13. A sheet of flexible gelled ceramic and/or metallic containing material comprising ceramic and/or metallic powder dispersed within an aqueous compatible cross-linked polymer.

14. The sheet of flexible gelled ceramic and/or metallic containing material according to claim 13 wherein the polymer is selected from polymers having amide, amine, carboxylic acid and/or hydroxyl functionalities.

15. The sheet of flexible gelled ceramic and/or metallic containing material according to claim 13 wherein the polymer is selected from chitosan, polyvinylalcohol, gelatine, poly(allyl)amine, polyethylenimine, chitin, polyacrylic acid, polyvinylacrylate, polyacrylate, polyacrylamide, pectin, xanthan gum and mixtures thereof.

16. The sheet of flexible gelled ceramic and/or metallic containing material according to claim 13 wherein cross-linking of the aqueous compatible cross-linked polymer is achieved using a water soluble cross-linking agent precursor that is temperature activated.

17. The sheet of flexible gelled ceramic and/or metallic containing material according to claim 16 wherein the cross-linking agent precursor forms a multifunctional aldehyde upon temperature increase.

18. The sheet of flexible gelled ceramic and/or metallic containing material according to claim 16 wherein the cross-linking agent precursor forms a di-aldehyde upon temperature increase.

19. The sheet of flexible gelled ceramic and/or metallic containing material according to claim 16 wherein the cross-linking agent precursor is 2,5-dimethoxy-2,5-dihydrofuran (DHF).

20. The sheet of flexible gelled ceramic and/or metallic containing material according to claim 13 wherein the ceramic powder comprises one or more of alumina, zirconia, silica, titania, silicon nitride, silicon carbide and aluminium nitride.

21. The sheet of flexible gelled ceramic and/or metallic containing material according to claim 13 comprising further components selected from one or more of binders, dispersants, chelating agents, surfactants, defoaming and/or wetting agents, salts, colouring agents, buffers, acids and alkali.

22. A method of producing a ceramic and/or metallic component comprising the steps of:
(a) combining water, ceramic and/or metallic powder, polymer, plasticiser, water soluble cross-linking agent precursor and optional further components to produce a mixture;
(b) applying the mixture to a suitable substrate to form a layer of desired dimensions;
(c) exposing the layer to conditions suitable for cross-linking to occur;
(d) optionally removing from the substrate a flexible gelled material obtained following step (c);
(e) optionally drying the flexible gelled material;
(f) processing the flexible gelled material to desired shape;
(g) firing flexible gelled material of desired shape to produce a ceramic and/or metallic component.

23. The method according to claim 22 wherein the ceramic and/or metallic component is a component of a fuel cell, photo-voltaic cell, multi-layered capacitor or other micro-electronic component, prosthetic or surgical device, refractory equipment, fibre optic device or transmission equipment.

24. The method according to claim 22 wherein the polymer is selected from polymers having amide, amine, carboxylic acid and/or hydroxyl functionalities.

25. The method according to claim 22 wherein the polymer is selected from chitosan, polyvinylalcohol, gelatine, poly(allyl)amine, polyethylenimine, chitin, polyacrylic acid, polyvinylacrylate, polyacrylate, polyacrylamide, pectin, xanthan gum and mixtures thereof.

26. The method according to claim 22 wherein the water soluble cross-linking agent precursor is temperature activated.

27. The method according to claim 22 wherein the cross-linking agent precursor forms a multifunctional aldehyde upon temperature increase.

28. The method according to claim 22 wherein the cross-linking agent precursor forms a di-aldehyde upon temperature increase.

29. The method according to claim 22 wherein the cross-linking agent precursor is 2,5-dimethoxy-2,5-dihydrofuran (DHF).

30. The method according to claim 22 wherein the ceramic powder comprises one or more of alumina, zirconia, silica, titania, silicon nitride, silicon carbide and aluminium nitride.

31. The method according to claim 22 wherein the optional further components comprise one or more of binders, dispersants, chelating agents, surfactants, defoaming and/or wetting agents, salts, colouring agents, buffers, acids and alkali.

32. A ceramic and/or metallic component produced by a method according to claim 22.

33. A method of producing a sheet of flexible gelled ceramic containing material, comprising the steps of:
(a) combining water, ceramic powder, polymer, plasticiser, water soluble cross-linking agent precursor and optional further components to produce a mixture;
(b) applying the mixture to a suitable substrate to form a layer of desired dimensions;
(c) exposing the layer to conditions suitable for cross-linking to occur;
wherein the polymer is selected from chitosan, polyvinylalcohol, gelatine, poly(allyl)amine, polyethylenimine, chitin, polyacrylic acid, polyvinylacrylate, polyacrylate, polyacrylamide, pectin, xanthan gum and mixtures thereof and wherein the cross-linking agent precursor forms a multifunctional aldehyde upon temperature increase.

34. The method according to claim 33 wherein the polymer is polyvinylalchohol.

35. The method according to claim 33 wherein the cross-linking agent precursor is 2,5-dimethoxy-2,5-dihydrofuran (DHF).

36. The method according to claim 33 wherein the ceramic powder comprises one or more of alumina, zirconia, silica, titania, silicon nitride, silicon carbide and aluminium nitride.

37. A sheet of flexible gelled ceramic containing material comprising ceramic powder dispersed within an aqueous compatible cross-linked polymer, wherein the polymer is selected from chitosan, polyvinylalcohol, gelatine, poly(allyl)amine, polyethylenimine, chitin, polyacrylic acid, polyvinylacrylate, polyacrylate, polyacrylamide, pectin, xanthan gum and mixtures thereof and wherein cross-linking is achieved using a cross-linking agent precursor that forms a multifunctional aldehyde upon temperature increase.

38. The flexible gelled ceramic containing material according to claim 37 wherein the polymer is polyvinylalchohol.

39. The flexible gelled ceramic containing material according to claim 37 wherein the cross-linking agent precursor is 2,5-dimethoxy-2,5-dihydrofuran (DHF).

40. The flexible gelled ceramic containing material according to claim 37 wherein the ceramic powder comprises one or more of alumina, zirconia, silica, titania, silicon nitride, silicon carbide and aluminium nitride.

41. A method of producing a ceramic component comprising the steps of:
(a) combining water, ceramic powder, polymer, plasticiser, water soluble cross-linking agent precursor and optional further components to produce a mixture;
(b) applying the mixture to a suitable substrate to form a layer of desired dimensions;
(c) exposing the layer to conditions suitable for cross-linking to occur;
(d) optionally removing from the substrate a flexible gelled material obtained following step (c);
(e) optionally drying the flexible gelled material;
(f) processing the flexible gelled material to desired shape;
(g) firing flexible gelled material of desired shape to produce a ceramic component;
wherein the polymer is selected from chitosan, polyvinylalcohol, gelatine, poly(allyl)amine, polyethylenimine, chitin, polyacrylic acid, polyvinylacrylate, polyacrylate, polyacrylamide, pectin, xanthan gum and mixtures thereof and wherein the cross-linking agent precursor forms a multifunctional aldehyde upon temperature increase.

42. The method according to claim 41 wherein the polymer is polyvinylalchohol.

43. The method according to claim 41 wherein the cross-linking agent precursor is 2,5-dimethoxy-2,5-dihydrofuran (DHF).

44. The method according to claim 41 wherein the ceramic powder comprises one or more of alumina, zirconia, silica, titania, silicon nitride, silicon carbide and aluminium nitride.
